(19) United States
(12) Patent Application Publication
(10) Pub. No.: US 2022/0111913 A1
(43) Pub. Date: Apr. 14, 2022

(54) MOBILE DRIVE UNIT AND METHOD OF OPERATION

(71) Applicant: OCTINION BVBA, Heverlee (BE)

(72) Inventors: Wouter STANDAERT, Knesselare (BE); Dieter KINDT, Vladslo (BE); Rob CARDINAELS, Zonhoven (BE); Martijn SCHAEKEN, Leuven (BE); Laura GUILLAUME, Leuven (BE); Dries GIELIS, Everberg (BE); Tom COEN, Zemst (BE)

(21) Appl. No.: 17/423,684

(22) PCT Filed: Sep. 21, 2019
(86) PCT No.: PCT/EP2019/075438

§ 371 Date: Jul. 16, 2021

Related U.S. Application Data
(60) Provisional application No. 62/734,331, filed on Sep. 21, 2018.
(60) Provisional application No. 62/734,358, filed on Sep. 21, 2018.

(51) Int. Cl. B62D 49/06; B62D 7/04; G05D 1/02; B60L 53/14; B60L 53/36

(52) U.S. Cl. CPC B62D 49/065; B62D 7/04; G05D 1/0225; A01D 46/30; B60L 53/36; G05D 2201/0201; B60L 2200/40; B60L 53/14

(57) ABSTRACT

There is described a mobile drive system comprising at least one mobile drive unit capable of automated or autonomous navigation, wherein the mobile drive unit comprises: a platform comprising U or V type shape, the platform comprising two legs and a bent or front interconnector interconnecting both legs at one end; a first wheelset comprising two wheels, each arranged at a corresponding distal end of the legs of the platform; and a second wheelset comprising two or only one wheel at the interconnector of the platform.

### FIELD

There is described a mobile drive unit and method of operation related to the technical field of autonomous or automated robotic or automation platforms, which are able to perform automated tasks, more particularly in the field of agriculture, horticulture, etc. Such tasks for example include operations such as logistics, scouting, monitoring, harvesting, weeding, spraying, fertilizing, feeding, gathering, cleaning, etc. of agricultural or horticultural produce or animals and could be performed in indoor and/or outdoor environments.

### PRIOR ART

Prior art mobile drive units for autonomous or automated robotic or automation platforms, such as for example WO2018015416 which describes a robotic device for picking fruit.

However, especially in agricultural, horticultural and similar applications, there still exists a need for improvements, such as a more simple, efficient, robust and flexible mobile drive unit, mobile drive system and method of operating such a mobile drive system. This is especially the case when a mobile drive system is involved with a plurality of mobile drive units which need to flexibly perform a plurality of different tasks such as monitoring, harvesting, logistics, etc.

### SUMMARY

In order to overcome the above-mentioned problem, according to a first aspect of the invention, there is provided a mobile drive system comprising at least one mobile drive unit capable of automated or autonomous navigation, wherein the mobile drive unit comprises:

a platform comprising U or V type shape, the platform comprising two legs and a bent or front interconnector interconnecting both legs at one end;
a first wheelset comprising two wheels, each arranged at a corresponding distal end of the legs of the platform; and
a second wheelset comprising two or only one wheel at the interconnector of the platform.

In this way a simple, flexible and stable mobile drive unit is realized that can be used for coupling with a plurality of different implement units in an efficient way, thereby allowing for a flexible and efficient mobile drive system making use of such mobile drive units. Preferably, when the second wheelset comprises two wheels, the wheels are mounted to the platform by means of a suitable pivotal system and/or by means of a suitable suspension system for providing a suitable level of dampening and/or compensation. Optionally also the wheels of the first wheelset could be each mounted individually to the platform by means of a pivotal system and/or by means of a suitable suspension system for providing a suitable level of dampening and/or compensation.

According to an embodiment, there is provided a mobile drive system, wherein the mobile drive system further comprises at least one implement unit, wherein the implement unit is configured to be removably coupled at the legs of the platform of the mobile drive unit, such that the mobile drive unit automatically drives the implement unit when coupled.

This allows for an efficient, flexible and simple mobile drive system, as a mobile drive unit can be shared among a plurality of different implement units, and the complexity of the implement units can be reduced as the components for the functions of the mobile drive unit is provided for by the mobile drive unit in a shared way. Such an approach is for example particularly advantageous in the context of a drive system supporting agricultural or horticultural operations, as in such a context different implements are used at different time periods, such as for example a scouting implement prior to harvesting to monitor for diseases, pest and ripeness of the produce, a spraying or other treatment implement when a disease or pest is detected, a harvesting implement during subsequent harvesting operations as the produce has reached the desired ripeness state, etc. In this way the mobile drive unit can be applied in a shared way for the different implements at the appropriate time period when the particular operations of the implement are needed. According to a particular embodiment, this for example allows for a continuous use of an implement during a prolonged period, for a period covering a plurality of days, without the need for a prolonged stand still or extensive distances covered because of the need for battery charging. As described further below, when the system comprises a plurality of mobile drive units comprising a suitable battery, the mobile drive units function as an energy provider/carrier for the implement unit. When the battery power of a drive unit is almost depleted by use by all energy users, such as for example the driving energy usage as well as the required energy to operate the implement unit, the depleted mobile drive unit can be exchanged for a charged mobile drive unit, which is called to the location where the implement unit is currently operation. In this way the implement does not need to cover the distance to the charging station and a faster resumption of the tasks of the implement unit is possible, as it only needs to be interrupted for uncoupling the depleted mobile drive unit and subsequently coupling the charged mobile drive unit. The U or V type shape of the mobile operating system also allows for the point of gravity of both the mobile drive unit and the implement unit to remain low, thereby improving stability, especially in the coupled state.

According to a further embodiment, there is provided a mobile drive system, wherein the mobile drive system is configured such that coupling of one of the mobile drive units and one of the implement units is performed by driving the mobile drive unit to the implement unit, such that an implement coupling part of the implement unit is positioned at a drive unit coupling part at the legs of the platform, and wherein the implement coupling part of the implement unit comprises suitable guide elements which cooperate with corresponding guide elements at the inside of the legs of the platform of the drive unit coupling part of the mobile drive unit during coupling, in order to assist alignment of the implement coupling part of the implement unit with the drive unit coupling part of the mobile drive unit. It is clear that further embodiments are possible which also comprise further guide elements that are arranged on different positions on the legs and/or the interconnector of the mobile drive system, such as for example interlocking guide elements arranged on the top surface of the legs and/or the implement, that cooperate with corresponding guide elements on the coupling part of the implement unit during coupling and in the coupled state.

This allows for a simple and reliable coupling operation.

According to a further embodiment, there is provided a mobile drive system, wherein the implement unit is configured such that, when coupled to a mobile drive unit, the point of gravity of the implement unit is situated:

in between the legs of the platform of the mobile drive unit and/or the longitudinal axis of the legs when seen from above;
in between the first wheelset and the second wheelset of the mobile drive unit;
above the drive unit coupling part and/or the implement coupling part; and/or
in between the second wheelset of the mobile drive unit and a wheelset of the implement unit, when the implement unit comprises a towable implement unit comprising at least one wheelset at a distal end of the towable implement unit facing away from the mobile drive unit.

In this way a stable and secure coupling can be realized.

According to a further embodiment, there is provided a mobile drive system, wherein the mobile drive system comprises at least one implement lifting module which is configured to lift and/or lower the implement unit during coupling and/or uncoupling with the mobile drive unit, and wherein the lifting modules:

are standalone units; or
are integrated into the implement units; or
are integrated into the mobile drive units.

In this way a reliable and simple coupling and uncoupling operation can be realized. It is however clear, that as described in further detail below, according to alternative embodiments, the mobile drive system and the implement are configured to couple and/or uncouple without the need for an implement lifting module, by means of driving the coupling part of the implement unit in between and/or out of the legs of the drive unit, preferably in cooperation with a suitable docking station and/or charging station, which retains the uncoupled implement unit.

According to a further embodiment, there is provided a mobile drive system, wherein the mobile drive unit further comprises a wheel lifting module configured to lift and/or lower the wheels of the first wheelset.

In this way, when coupled with a towable implement unit, the first wheelset can be lifted, thereby enabling the combination of the mobile drive unit and the towable implement unit to make use of a more simple, robust and reliable coupling and steering strategy. Additionally, such a wheel lifting module can also function as a lifting module by lifting and lowering the distal end of the platform by means of the wheel lifting module which can be used to couple or decouple the implement.

According to a further embodiment, there is provided a mobile drive system, wherein the mobile drive system further comprises at least one charging station for the at least one mobile drive unit and/or the at least one implement unit, wherein the mobile drive system is configured such that the mobile drive unit:

approaches the charging station in the same way as for coupling an implement unit; and/or
is removably couplable to the charging station in the same way as to an implement unit; and/or
is guided during coupling by guide elements of the charging station which cooperate with corresponding guide elements at the inside of the legs of the platform of the drive unit coupling part of the mobile drive unit and/or with the wheels of the mobile drive unit; and/or
when approaching the charging station in a coupled state with an implement unit, thereby coupling the implement unit to the charging station, the mobile drive unit receives power from the charging station via the coupled implement unit.

In this way the mobile drive system provides for a flexible, robust and modular way to charge the mobile drive units and the implements.

According to a further embodiment, the mobile drive system for example comprises at least one mobile drive unit, at least one charging station and at least one docking station, which can also be referred to as an implement parking device and which can be mechanically similar to a charging station or a similar station without the charging capabilities but visually looking the same. As described above, when a mobile drive unit carrying or towing an implement unit needs to be charged because for example its battery unit is depleted, the depleted mobile drive unit parks the implement unit for example on the such parking station nearby, after which the depleted mobile drive unit can go charging on a charging station, while in the meantime the implement unit is picked up by another already charged mobile dive unit, thereby ensuring a minimal stand still time of the implement unit. In case of towed implement units, the towed implement unit can for example also be parked, for example in the row in between the produce with the support of a parking device that is integrated into the implement unit itself, for example realized by at least one parking foot is configured to be lowered to a parking state and again lifted during an operational state of the implement unit. In this way the integrated parking device is thus actuated to support such a towed implement in such a way that it prevents the towed implement to fall down in the parked state, when it is not supported by a mobile drive unit. This concept for towable implement units can also be used for carried implements. It is clear that in this way also the distance to the charging station and/or the parking station does not need to be covered by the implement unit, which is advantageous when this would result in a too large time slot wherein the implement unit is not in use for performing time critical operations.

According to a further embodiment, there is provided a mobile drive system, which comprises an automated logistic system comprising at least one mobile operating unit, each mobile operating unit comprising a combination of one mobile drive unit coupled to at least one implement unit, whereby the mobile operating unit is configured to:

receive at least one container at an input location at a predetermined input side of the mobile operating unit;
manipulate items in one or more containers of the containers, thereby changing the filling level of the one or more containers;
release at least one container at an output location which is at the same side of the mobile operating unit as the input location.

In this way the shared use of mobile drive units and implement units allows for a flexible deployment of different mobile operating units providing for a simple and efficient logistic system for the mobile drive system.

According to a further embodiment, there is provided a mobile drive system, wherein the mobile operating unit is configured such that:

the inputted containers at the input position of the mobile operating unit are transported to an operating position along a first transport path;
then, at the operating position, the filling level of the container is changed;
after changing the filling level, the container is transported from the operating position to the output position along a second transport path with an opposite direction to the first transport path.

According to a further embodiment, there is provided a mobile drive system, wherein the first transport path and the second transport path are parallel and/or wherein the first transport path and the second transport path are arranged one on top of the other, and/or next to each other; and wherein the first and/or second transport path are configured to buffer a plurality of containers, preferably in a fifo along the transport direction.

According to a further embodiment, there is provided a mobile drive system, wherein, at the operating position, the mobile operating unit comprises a reversing path changing module, wherein the path changing module is configured to:

after transport of the container along the first transport direction when received from the input of the first transport path towards the exit of the first transport path;
receive a container from the exit of a first transport path;
after changing the filling level of the container at the operating position;
offer the container to the input of the second transport path;
subsequently transport the container along the opposite second transport direction when releasing the container to the input of the second transport path.

According to a further embodiment, there is provided a mobile drive system, wherein at least one first and second transport path are arranged on top of each other, and wherein the path changing module comprises a lift configured to:

receive a container at the height of the first transport path; and
change the height of the container to the height of the second transport path when releasing the container towards the output location; and/or
change the height of the container to a height different from the first and/or second transport path to an operating position in which the filling level of the container is changed, after receiving the container at the height of the first transport path and before releasing the container at the height of the second transport path.

According to a further embodiment, there is provided a mobile drive system, wherein there are arranged at least two first transport paths next to each other; and/or at least two corresponding second transport paths next to each other, each comprising an associated path changing module at an associated operating position.

This allows for a simple and efficient buffering capacity, as well as the possibility for continued harvesting operations even during exchange of containers.

According to a further embodiment, there is provided a mobile drive system, wherein the logistics system further comprises at least one mobile operating unit configured as a mobile supply unit, which comprises at least one corresponding first and second transport path for the containers, which, are positioned such that a sequence of at least one mobile supply unit can be positioned next to one of the at least one mobile operating units in such a way that the first and second transport paths of the mobile operating unit and the sequence of the at least one mobile supply units form a fifo along the respective transport directions, thereby allowing an exchange of containers between the sequence of at least one mobile operating units and/or at least one mobile supply units.

In this way, the efficiency of the mobile drive system is further optimized, as for example a mobile operating unit comprising a harvesting implement can continue its harvesting operations, while intermittently a mobile supply unit provides new empty containers and extracts the full containers.

It is clear that several of the embodiments described above and below are also advantageous when applied to a mobile drive system comprising a mobile drive unit which does not comprise a platform with a U or V type shape, but any other suitable shape.

According to a second aspect of the invention, there is provided a method of operating a mobile drive system according to any of the preceding claims, wherein the mobile drive system operates at least one of said mobile drive units in shared way with a plurality of said implement units.

According to a third aspect of the invention, there is provided a method, wherein, the mobile drive unit comprises a controller configured to operate by means of a plurality of nested control loops, each comprising one or more finite state machines, in which, when coupled to an implement unit, there are only exchanged operational instructions from the mobile drive unit for the implement unit and/or vice versa at the level of the top level control loop.

In this way a safe, simple and robust, uniform and well defined communication strategy between the implement unit and the mobile drive unit is realized. Any communication exchanged at the lower levels is solely restricted to a data exchange, this means passive data exchange, for example for monitoring the correct operation of the coupled units in order to determine an error state which would require a shutdown or other safety mechanism to be triggered in case of anomalous operational states, and which does not comprise any operational instructions for operating the other coupled unit, such as for example the implement instruction the mobile operating vehicle and/or vice versa to perform one or more operational tasks, such as for example navigation along a path, performing a harvesting operation, etc.

According to an aspect of the invention there is provided a mobile drive unit capable of automated or autonomous navigation.

According to an embodiment there is provided a mobile drive unit, wherein the mobile drive unit comprises a U or V type shape. It is clear that this thus means as seen from above.

According to an embodiment there is provided a mobile drive unit, wherein the mobile drive unit comprises:

two wheels at the distal end of the legs of the U or V type shape; and
two or only one wheel at the bent or front of the U or V type shape

According to an embodiment there is provided a mobile drive unit, wherein at least the second wheel are caster wheels and comprise a drive system which can actively power rotation and steering direction of the caster wheels.

According to an embodiment there is provided a mobile drive unit, wherein the first wheels comprise a drive system which can actively power rotation of the wheel(s).

According to a further embodiment, there is provided a mobile drive system comprising at least one such mobile drive unit and at least one implement unit, wherein the implement unit is configured to be removably coupled at the legs of the U or V shape of the mobile drive unit, such that the mobile drive unit automatically drives the implement unit when coupled.

According to a further embodiment, there is provided a mobile drive system, wherein implement unit is configured such that, when coupled to a mobile drive unit, its point of gravity is situated between the legs of the U or V type shape of the mobile drive unit.

According to a further embodiment, there is provided a mobile drive system, wherein the mobile drive unit comprises an energy storage unit, such as for example a battery, and in which the mobile drive unit is configured to provide energy to the implement unit when coupled.

According to a further embodiment, there is provided a mobile drive system, wherein the system is configured such that the energy level of a mobile drive unit driving and powering an implement unit is monitored, and when the energy level is below a predetermined threshold, the mobile drive unit uncouples from the implement unit and is automatically replaced by another mobile drive unit which subsequently couples to the implement for driving and/or powering it.

As described above, according to a further embodiment, the implement unit could comprise a suitable implement parking device configured to allow the implement unit to rest on the ground when uncoupled from a mobile drive unit. According to still a further embodiment there could be provided suitable docking and/or parking stations configured to let an implement rest thereon to allow for uncoupling and coupling of the mobile drive unit. It is clear that the mobile drive system could comprise a plurality of such parking stations, and that preferably the mobile drive system comprises a larger number of parking stations then charging stations, and in which preferably the parking stations are suitable distributed along the area covered by the implement units.

According to a further embodiment, there is provided a mobile drive system, wherein coupling of the mobile drive unit and the implement unit is performed by driving the mobile drive unit to the implement unit, such that the implement is positioned at the legs of the U or the V type shape.

According to a further embodiment, there is provided a mobile drive system, wherein the implement unit comprises suitable guide elements which cooperate at least with the inside of the legs of the U or V type shape of the mobile drive unit during coupling in order to assist alignment of the implement unit with the mobile drive unit.

According to a further embodiment, there is provided a mobile drive system, wherein there is provide at least one docking module which is able to lift and/or lower the implement unit during or after coupling with a mobile drive unit.

According to a further embodiment, there is provided a mobile drive system, wherein the docking modules:

are standalone units; or
are integrated into the implement units; or
are integrated into the drive units.

According to a further embodiment, there is provided a mobile drive system, in which the charging station is integrated into the docking module. According to a particular embodiment the docking module allows for coupling and uncoupling of the implement. According to a particular embodiment, the docking module allows for automatic coupling and/or uncoupling of the implement unit by driving the mobile drive unit along the docking module such that the implement unit is inserted in and/or extracted from between the legs of the mobile drive unit.

According to a further embodiment, there is provided a mobile drive system, comprising at least one charging station for the mobile drive unit; and/or the implement unit.

According to a further embodiment, there is provided a mobile drive system, in which preferably the mobile drive unit:

approaches the charging station in the same way as for coupling an implement unit; and/or
is removably couplable to the charging station in the same way as to an implement unit; and/or
is guided during coupling by guide elements of the charging station which cooperate with the inside of the legs of the U or V type shape of the mobile drive unit.

According to a further embodiment, there is provided a mobile drive system, in which the charging station is integrated into the docking module.

According to an aspect of the invention, there is provided an automated logistic system comprising at least one mobile drive unit or vehicle which is configured to navigate in an automated or autonomous way, at least one of the drive units being configured as a mobile operating unit manipulating items in a plurality of containers, thereby changing the filling level of the containers, in which the mobile operating unit or operating vehicle is configured to:

receive/input at least one container at an input location at a predetermined input side of the mobile operating unit;
changes the filling level of the container;
release/output at least one container at an output location which is at the same side of the mobile operating unit as the input location.

The filling level of the containers during operation is for example changed from empty to full, or vice versa. The side of the vehicle of the input and output location is for example at the back of the vehicle when viewed along its general direction of movement.

According to an embodiment there is provided a system, wherein:

the inputted containers at the input position of the mobile operating unit are transported to an operating position along a first transport path;
when at the operating position the filling level of the container is changed;
after changing the filling level, the container is transported from the operating position to the output position in a second transport path with an opposite direction to the first transport path.

According to a further embodiment there is provided a system, wherein the first transport path and the second transport path are parallel.

According to a further embodiment there is provided a system, wherein the first transport path and the second transport path are arranged one on top of the other, and/or next to each other.

According to a further embodiment there is provided a system, wherein, at the operating position, the mobile operating unit comprises a path changing module.

According to a further embodiment there is provided a system, wherein the path changing module is configured to;

receive a container from the exit of a first transport path;
after changing the filling level of the container;
offer the container to the input of the second transport path.

According to a further embodiment there is provided a system, wherein the path changing module comprises a reversing transport element, which is configured to:

transport the container along the first transport direction when received from the output of the first transport path
transport the container along the opposite second transport direction when releasing the container to the input of the second transport path.

According to a further embodiment there is provided a system, wherein at least one first and second transport path are arranged on top of each other, and wherein the path changing module comprises a lift configured to:

receive a container at the height of the first transport path; and
change the height of the container to the height of the second transport path when releasing the container.

According to a further embodiment there is provided a system, wherein the first and/or second transport path are configured to buffer a plurality of containers, preferably in a fifo along the transport direction.

According to a further embodiment there is provided a system, wherein there are arranged at least two first transport paths next to each other; and/or at least two corresponding second transport paths next to each other, each comprising an associated path changing module at an associated operating position.

This allows to continue the operation changing the filling level of the container at one operating position, while another path changing module is busy with changing a container of which the filling level was changed to another transport path. In the annexes there are shown a first transport path on top of a second transport path for moving crates for an operating vehicle for harvesting. The harvested goods are deposited in the crates at an operating position where a lift system serves as a path changing module that lowers the crates once full. As shown this setup is duplicated symmetrically, one left of the vehicle and one right of the vehicle. It is clear that, while a full crate at the left side is being lowered by the lift from the operating position, to be released to the lower transport path, at the right side a crate which is not yet full can continue to receive harvested goods. When left full crate is provided to the lower transport path, the lift system raises again to the upper position of the first transport path to receive a new empty crate, upon which filling of this empty crate can be started again. This enables a continuous filling action of the application even when a fill crate is moved from the operation position to a buffer position. It further for example also allows for differentiated filling of the crates with selected items based on specific properties of these items, such as properties as the size, quality, etc. of the harvested produce.

It is clear that, in this way, a cyclic concept can be realized in which empty containers can be loaded and full containers can be unloaded in a double fifo queue with opposing directions at the same side of the operating vehicle. The cycle is looped at the path changing module where the direction of the fifo queue is reversed.

According to a further embodiment, there is provided a system, wherein the system further comprises at least one mobile supply unit or mobile operating vehicle, which comprises at least one corresponding first and second transport path for the containers, which, are positioned such that a sequence of at least one transport vehicle can be positioned next to the operating vehicle in such a way that the first and second transport paths of the operating vehicle and the supply vehicle(s) form a fifo along the respective transport directions, thereby allowing an exchange of containers between the vehicles.

According to a further embodiment there is provided a system, wherein at least one of the transport paths, preferably the second transport path, of the operating vehicles and/or the supply vehicles is provided with:

a cooling unit, such as for example a cooling unit for cooling harvested goods;
a unit for determining the weight of the containers.

According to a further embodiment there is provided a system, wherein, when exchanging containers between the operating vehicle and the transport vehicle, optionally there could also be an exchange of energy between the operating vehicle and the transport vehicle. Measuring the incremental weight of the filled containers also allows for a yield sensor that is configured to aggregate for example the yield of the harvested produce by the implement unit.

For example, the supply vehicle charges the battery of the operating vehicle or exchanges a depleted battery of the transport vehicle with a charged battery.

According to further embodiments there is provided a system comprising one or more of the following embodiments of such an operating vehicle and a supply vehicle as for example shown in the drawings, such as for example:

an embodiment of operating vehicle: agricultural robot for picking strawberries;
an embodiment of an operating vehicle and a supply vehicle enabling exchange of empty crates between operating vehicle and supply vehicle;
an embodiment of operating vehicle and supply vehicle and operation of a system in a cycle with opposing directions.

### DESCRIPTION

Exemplary embodiments of a system and method will now be described with respect to the drawings, in which:

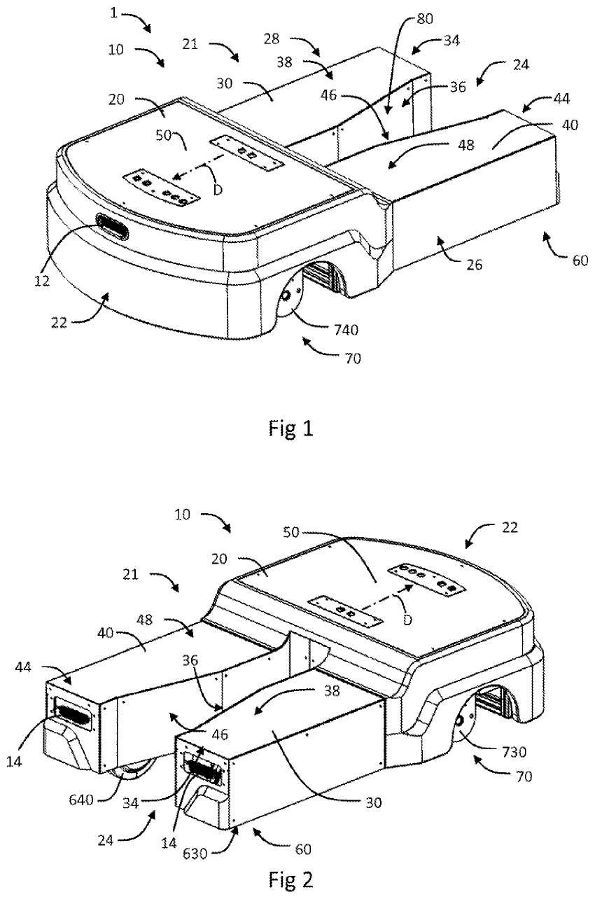

FIGS. 1 and 2 show different perspective views of an embodiment of a mobile drive unit;

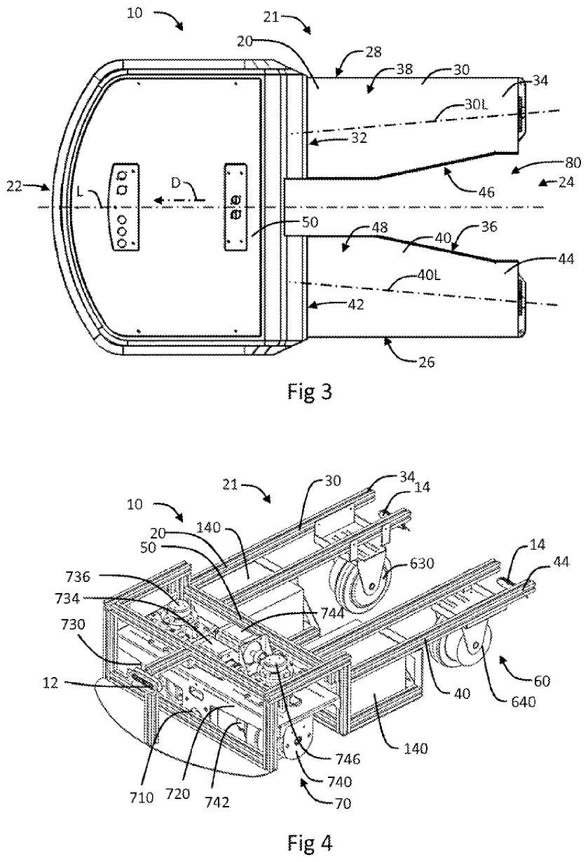

FIG. 3 shows a top view of the embodiment of FIGS. 1 and 2;

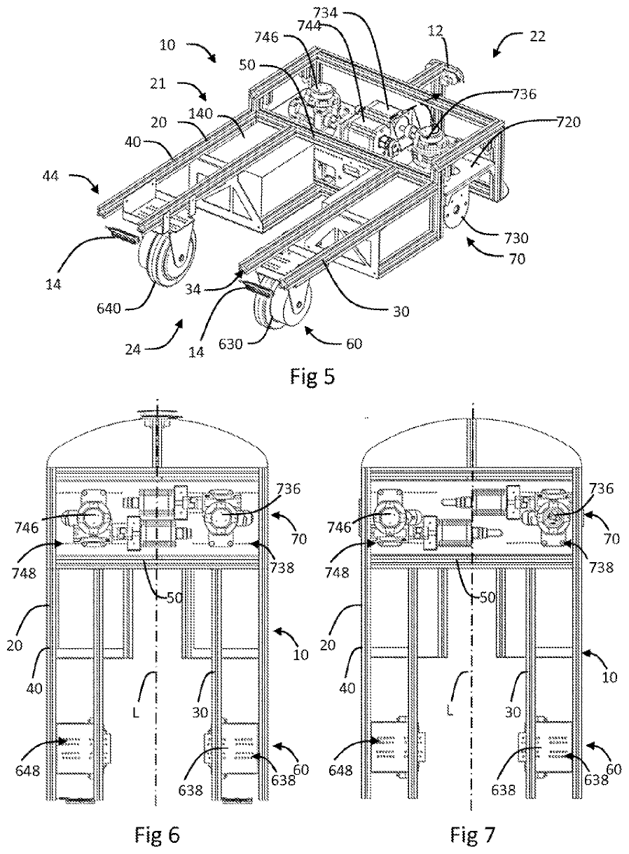

FIGS. 4 and 5 show perspective views of internal details of the embodiment of FIGS. 1-3;

FIGS. 6 and 7 show two different configurations of the embodiment of FIGS. 4 and 5;

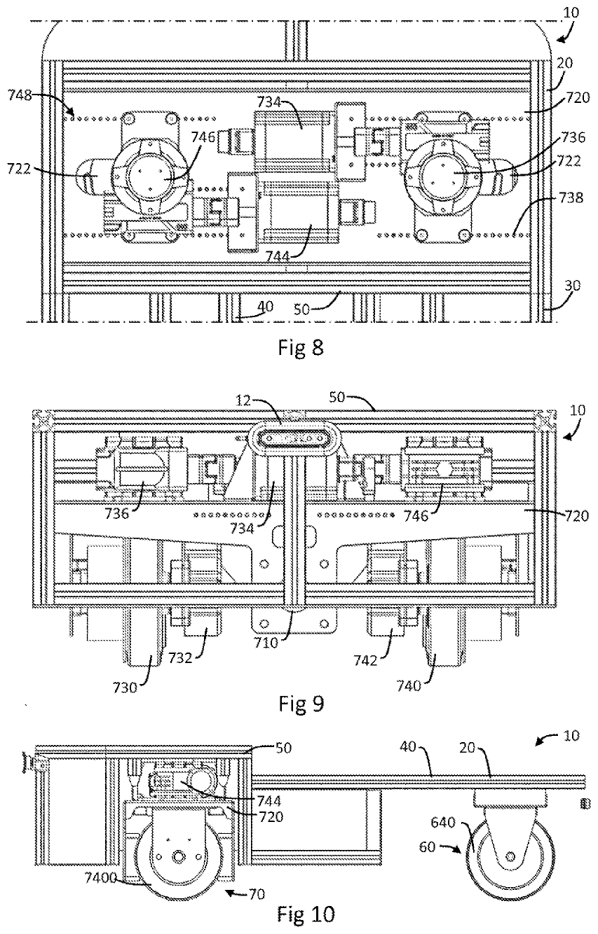

FIG. 8 shows a fragment of FIG. 6 in further detail;

FIGS. 9 and 10 show a front view and a side view of the embodiment of FIGS. 4 and 5;

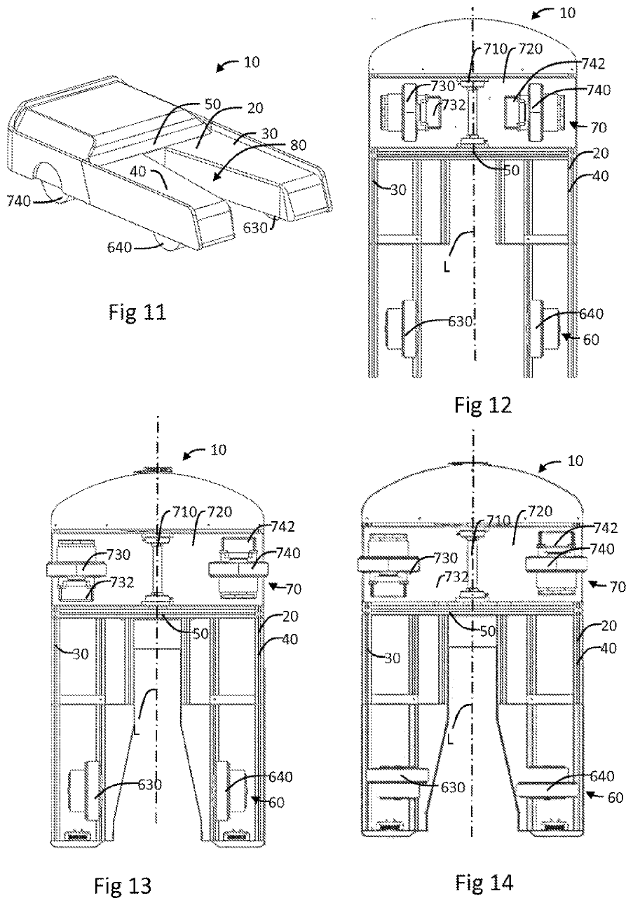

FIG. 11 shows an alternative embodiment of a mobile drive unit;

FIGS. 12-14 show the embodiment of FIGS. 1-10 with the wheels in different angular steering positions;

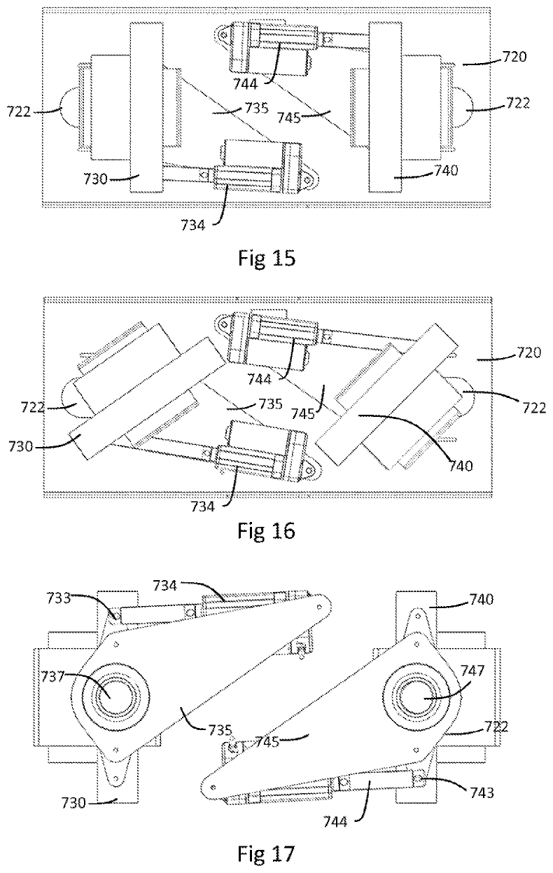

FIGS. 15-17 show an alternative embodiment of a steering mechanism for the mobile drive unit;

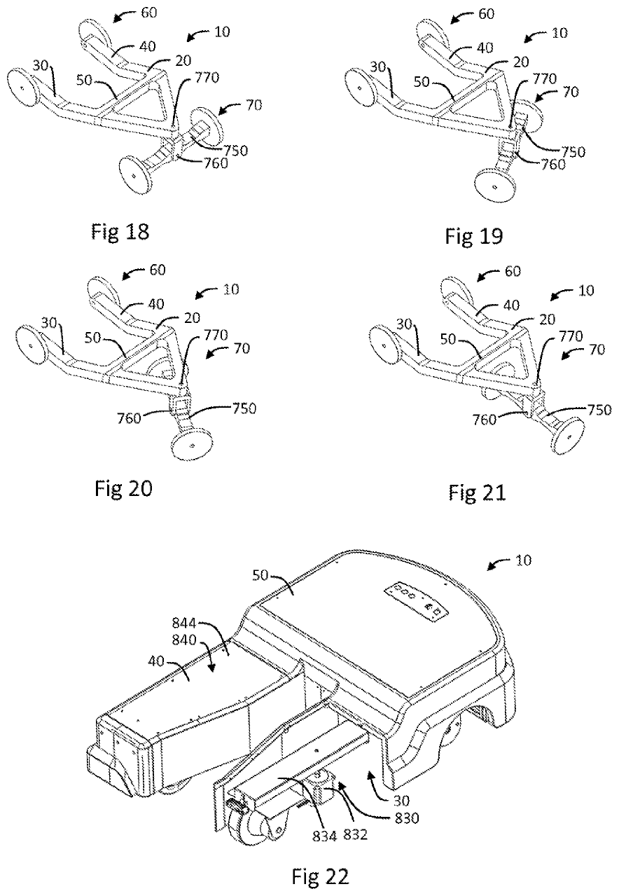

FIGS. 18-21 show a further alternative embodiment of a steering mechanism;

FIGS. 22-25 show different views of an embodiment of a mobile drive unit comprising an implement lifting module;

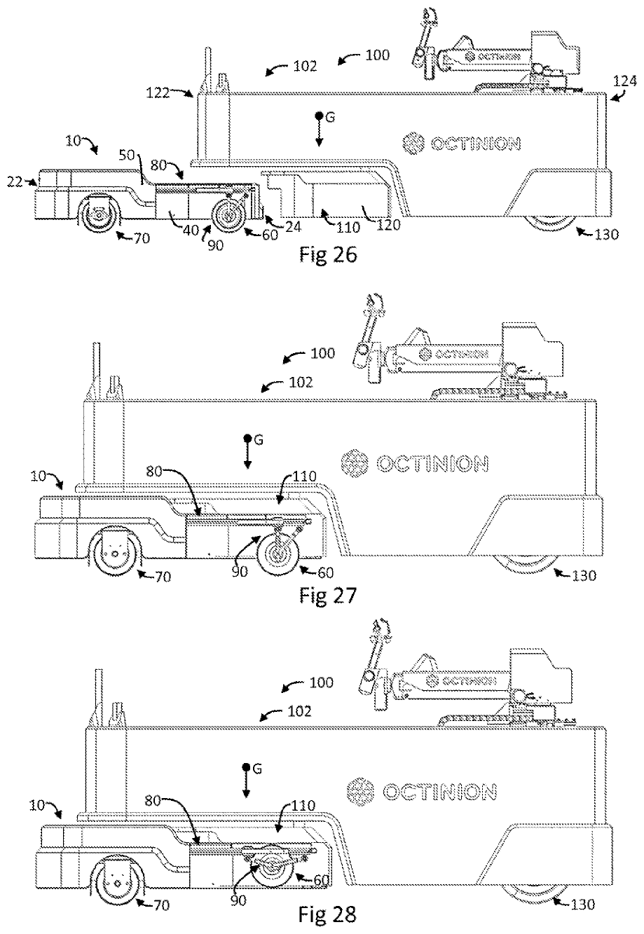

FIGS. 26-30 show different views of an embodiment of an implement lifting and wheel lifting module;

FIGS. 31-33 show different views of an alternative embodiment of an implement lifting and wheel lifting module;

FIGS. 34 and 35 show different states of an embodiment comprising a charging and docking station and for a mobile unit;

FIGS. 36 and 37 show different states of an alternative embodiment of a charging and docking station;

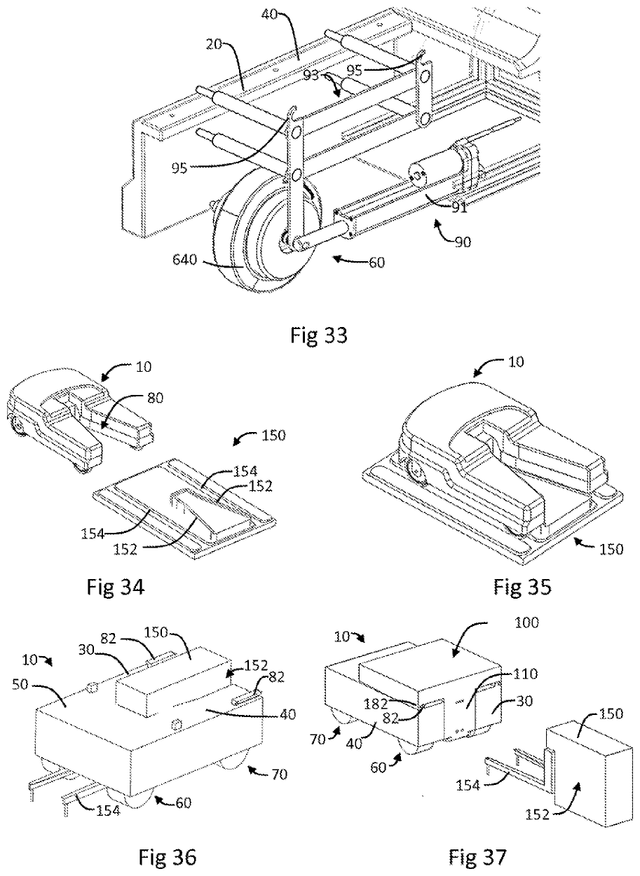

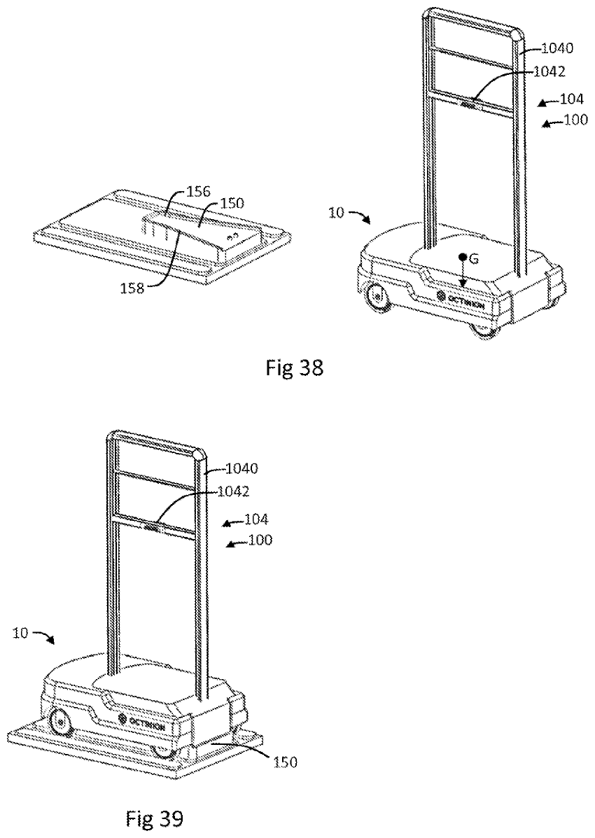

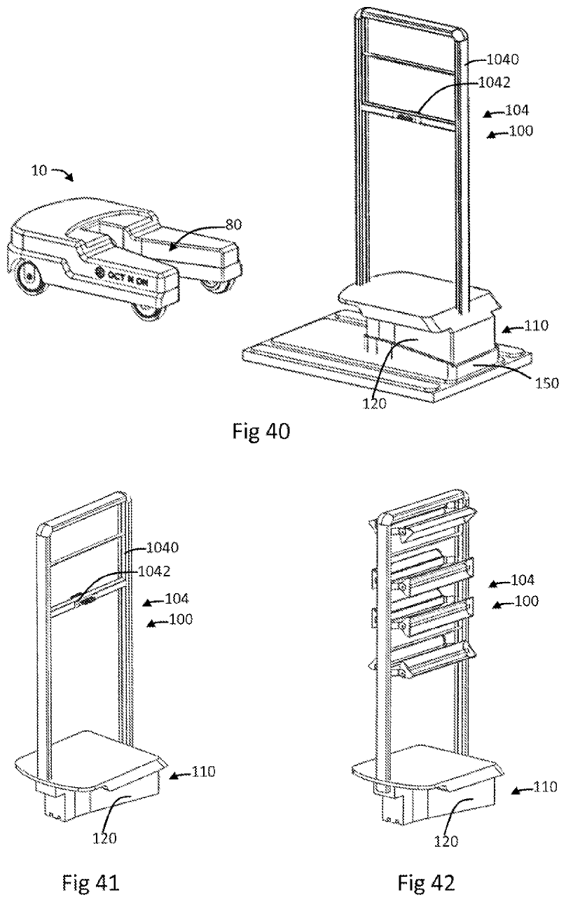

FIGS. 38-40 show different states of the embodiment of FIG. 33 for a mobile unit and a carriable implement;

FIGS. 41 and 42 show different embodiments of carriable implements;

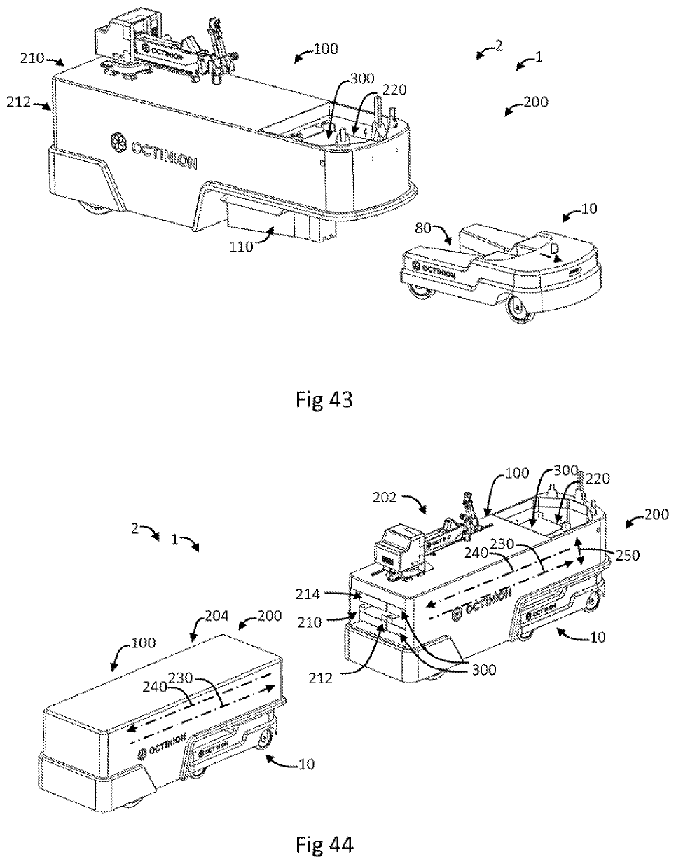

FIGS. 43-45 show different embodiments of towable implements;

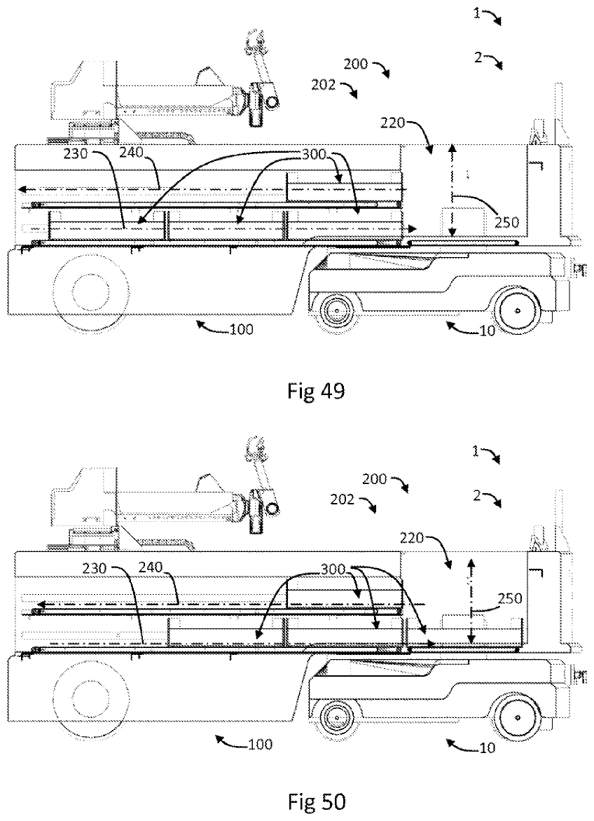

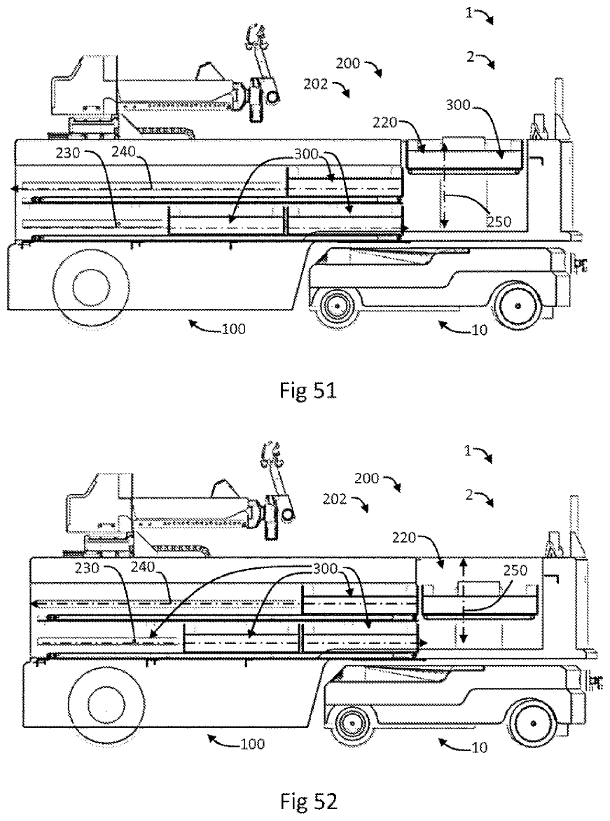

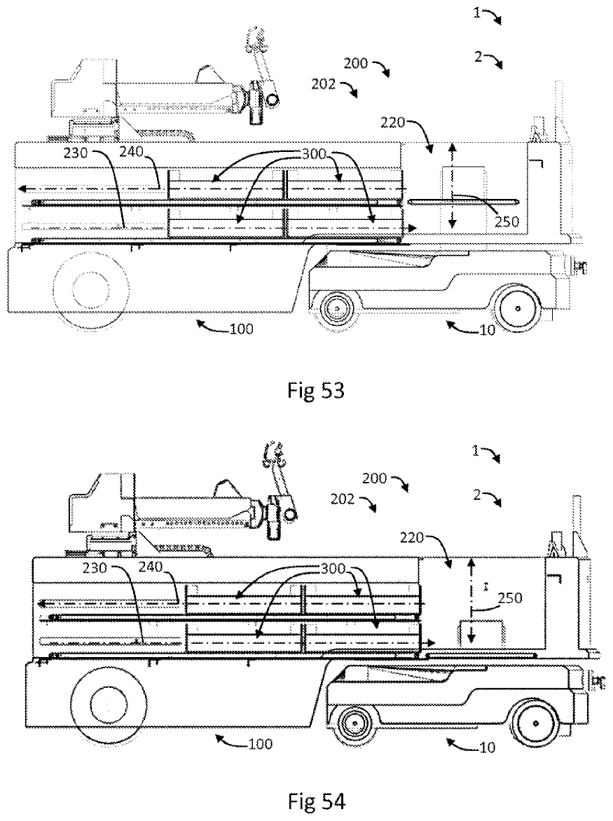

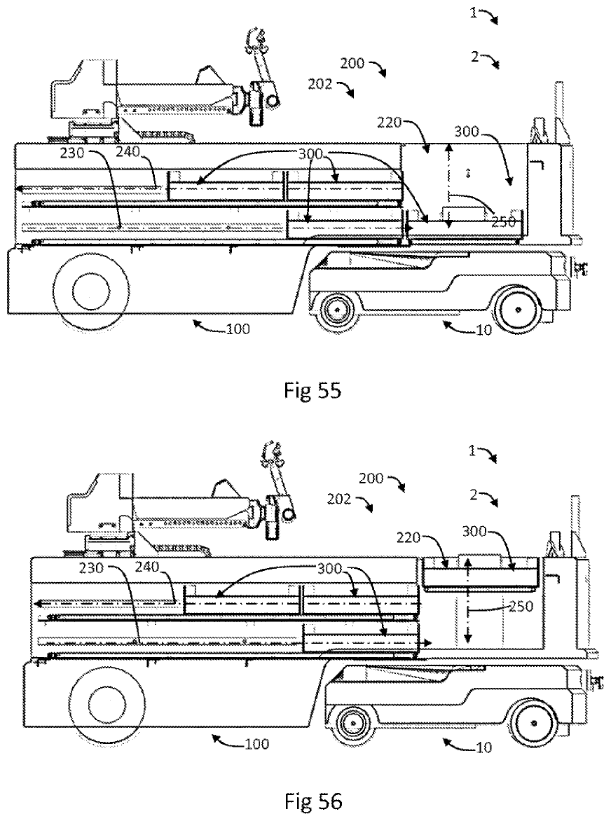

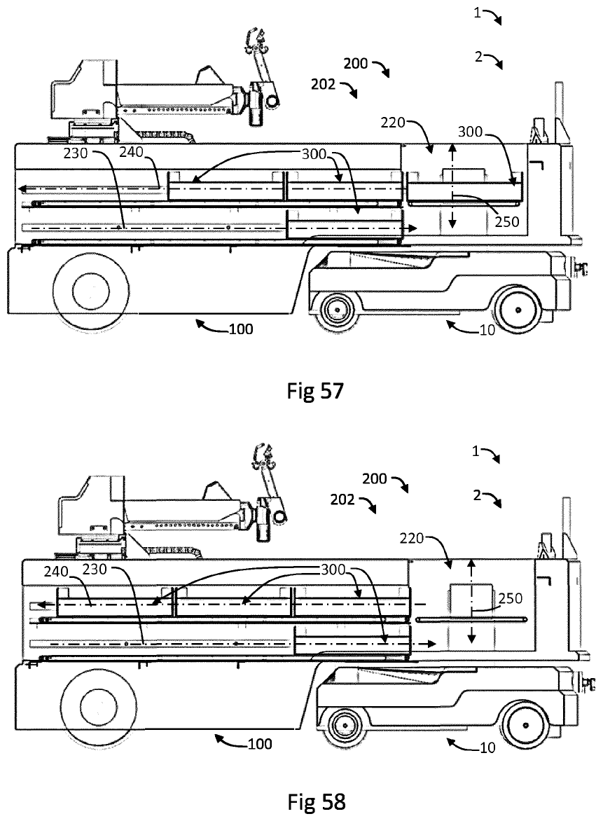

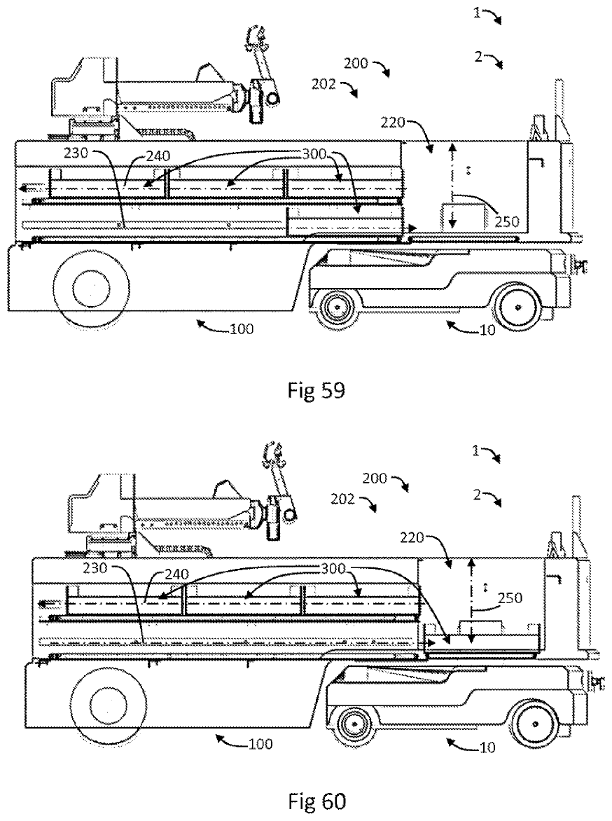

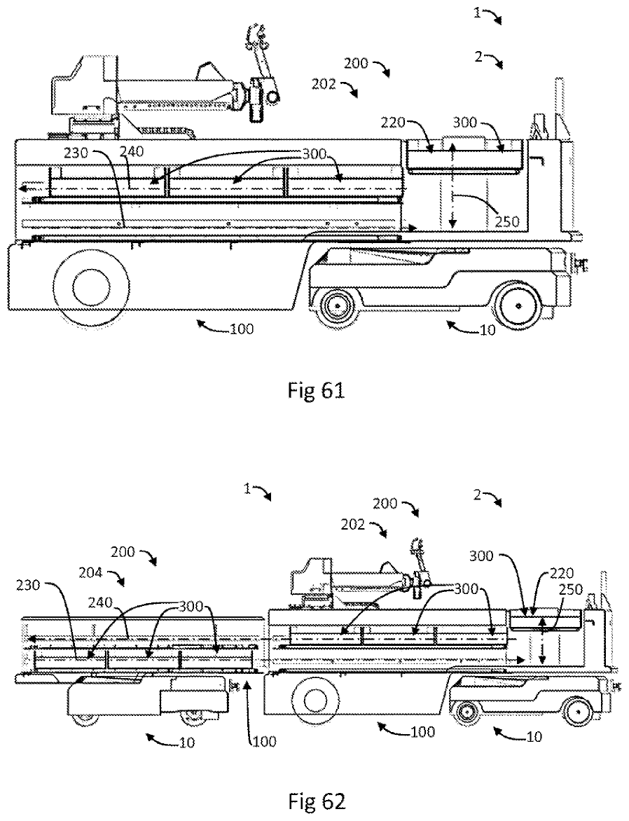

FIGS. 46-61 show different states of an embodiment of a mobile operating unit of an embodiment of a logistics system;

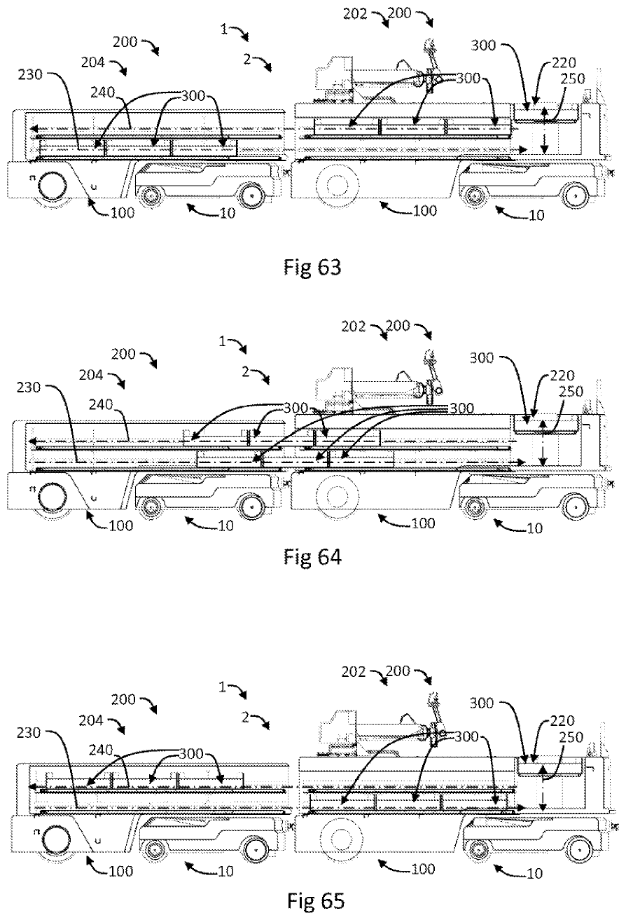

FIGS. 62-65 show different state of an embodiment of a logistics system comprising a plurality of mobile operating units; and

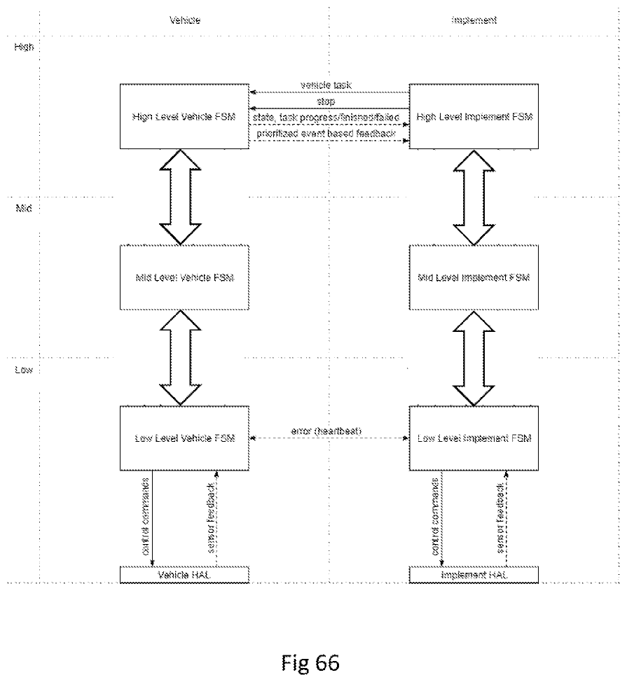

FIG. 66 shows an embodiment of a computer implemented method for operating the mobile drive system;

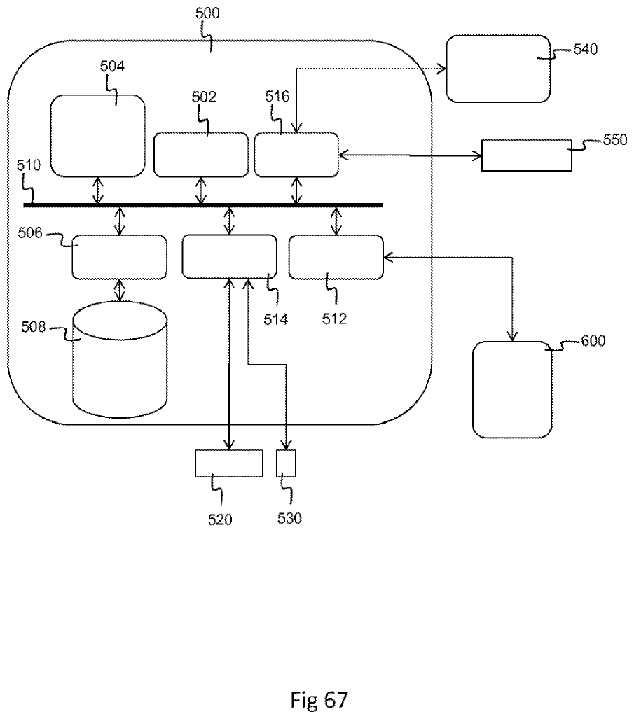

FIG. 67 shows an embodiment of a suitable computing system for implementing such a computer implemented method.

FIG. 1 and FIG. 2 shows a perspective view of an embodiment of a mobile drive unit 10 for a mobile drive system 1. The mobile drive unit 10 is capable of automated or autonomous navigation. The mobile drive system 1 realizes this by means of a suitably programmed controller making use of for example suitable sensors, navigation modules, . . . to allow the mobile drive unit 10 to navigate along a desired path in an automated and/or autonomous way. Such a mobile drive unit 10 can for example also be referred to as a robotic or automated vehicle. According to the embodiment shown in FIG. 1, the mobile drive unit 10 comprises a platform 20 comprising a U or V type shape 21. It is clear that this U or V type shape 21 refers to the shape of the platform 20 of the mobile drive unit 10 as seen from above. As shown, the U or V type shape 21 of the platform 20, which forms the frame of the mobile drive unit 10, is formed by means of two legs 30 and an interconnector 50. In other words, the platform 20 comprising two legs 30, 40 and a bent or front interconnector 50. As shown, the interconnector 50 thus forms the bent of the U shape, or the connection point of the V shape, or the front of the U or V shaped platform 20. It is clear that the interconnector 50 interconnects both legs 30, 40) at one end (32, 42). Both legs 30 thus extend longitudinally away from the interconnector 50 towards the same side of the platform 20. As shown in the top view of FIG. 3, according to this embodiment, both legs 30 are arranged mirror symmetrical, at opposing sides, with respect a central longitudinal axis L of the platform 20 along the movement direction indicated with arrow D of the mobile drive unit 10. As further shown, the longitudinal axis of the respective legs 30, 40 is substantially parallel or at an acute angle, for example an angle of 30° or less, with respect to the longitudinal axis L of the platform 20. As shown the interconnector 50 interconnects the legs 30, 40 across the central longitudinal axis L of the platform 20 at a first end 32, 42 of the respective legs 30, 40. It is clear that as shown, preferably this first end 32, 42 of both legs 30, 40 is located at the same position along the longitudinal axis L of the platform 20. As shown, when seen along the driving direction D, this side of the platform 20 could be referred to as the front side 22, and the opposing side of the platform 20 along the longitudinal axis L could be referred to as the back side 24, and as indicated sides 26, 28 could be referred to as the left side 26 and right side 28 of the platform 20. It is clear that this should be interpreted as relative indicators, as the platform 20 is for example able to drive along any suitable direction and for example also along a direction opposite, and/or transverse to the indicated driving direction D according to some embodiments. The leg 30 can thus be referenced as the right leg 30 and the leg 40 can thus be referenced as the left leg 40. The first end 32, 42 of the legs 30, 40 could thus be referred to as the front end 32, 42 of the legs 30, 40. It is thus clear that the interconnector 50 thus interconnects the front ends 32, 42 of the right leg 30 and the left leg 40 and extends across the central longitudinal axis L from the right leg 30 to the left leg 40. It is further clear that both legs 30, 40 extend longitudinally from their front end 32, 42 towards a distal end 34, 44 at the back side 24 of the platform 20. These distal ends 34, 44 can thus also be referred to as the back ends 34, 44 of the legs 30, 40.

As further shown in FIG. 1 and the different perspective view of FIG. 2, and as further shown more clearly in FIG. 4 and FIG. 5, the mobile drive unit 10 further comprises a first wheelset 600 comprising two wheels 630, 640, which can be referred to as the back wheels 630, 640. These two wheels 630, 640 are each respectively arranged at a corresponding distal end 34, 44 of the legs 30, 40 of the platform 20. In other words, as shown the first back wheel 630 is arranged at the back end 34 of the right leg 30 at the back side 24 of the platform 20. The second back wheel 640, is similarly arranged at the back end 44 of the left leg 40 at the back end of the platform 20. It is clear that these back wheels 630, 640 could be arranged at or near the back side 24 of the platform 20, as long as in general, they are arranged at the back side 24 with respect to the geometric center of the platform 20. It is further clear that the wheels are preferably located at a mirror symmetrical position with respect to the central longitudinal axis L of the platform 20.

As further shown, the mobile drive unit 10 further comprise a second set 70 of wheels comprising two wheels 730, 740 at the interconnector 50 of the platform 20. These two wheels 730, 740 are each respectively arranged at the interconnector 50 at the front end 22 of the platform 20. These two wheels can thus be referred to as the front wheels 730, 740. As shown, it is further clear that, preferably these two wheels are located at a mirror symmetrical position with respect to the central longitudinal axis L of the platform 20. In other words, as shown the first front wheel 730 is arranged at the at interconnector 50 at the front side 22 of the platform 20 at the right side 28 with respect to the central longitudinal axis L and can thus be referred to as the front, right wheel 730. The second front wheel 740, similarly is arranged at the interconnector 50 at the front side 22 of the platform 20 at the left side 26 with respect to the longitudinal central axis L of the platform. It is clear that these front wheels 730, 740 could be arranged at or near the front side 22 of the platform 20, as long as in general, they are arranged at the front side 22 with respect to the geometric center of the platform 20. It is clear that alternative embodiments are possible, in which for example the second set of wheels only comprises one wheel arranged at the interconnector. In such a case this single wheel, which can be referred to as the front wheel can for example be arranged at the interconnector 50 on a position on the central longitudinal axis L.

As shown, for example with reference to FIG. 26-FIG. 28, such mobile drive units 10 of the mobile drive system 1, are preferably configured to cooperate with implement units 100 of the mobile drive system 1. Such implement unit (100) is configured to be removably coupled at the legs 30, 40 of the platform 20 of the mobile drive unit 10. In this way, when coupled, the mobile drive unit 10 is able to automatically drive the implement unit 100. As shown the implement unit 100, is for example embodied as a towable implement unit 100 comprising its own set of wheels and for example comprising a fruit picking robot arm. However, according to alternative embodiments, such implement units 100 could be embodied as carriable implements, without wheels, that need to be carried entirely by the mobile drive units 100, such as for example shown in the embodiments of FIG. 38-FIG. 43. Preferably, as shown, the mobile drive system 1 is configured such that coupling of the mobile drive units 10 and implement unit 100 is performed by driving the mobile drive unit 10 to the implement unit 100, such that an implement coupling part 110 of the implement unit 100 is positioned at an drive unit coupling part 80 at the legs of 30, 40 of the platform 20 of the mobile drive unit 10. As shown in for example FIG. 1 to FIG. 3, the drive unit coupling part 80 comprises at least two guide elements 36 and 46 at the inside of the legs 30, 40 of the platform 20, this means at the opposing, inner sides of the legs 30, 40, which face each other and the longitudinal central axis L. In other words, the drive unit coupling part 80 borders a U or V shaped recess between the legs 30, 40 of the platform 20 of the mobile drive unit 10. The shape of the recess can, according to alternative embodiments divert from the specific shape shown, as long as in general it retains a more or less V or U type shape, of which preferably the distance between the legs 30, 40 at the back side 24 of the platform 20, at the distal end 34, 44 of the legs 30, 40 is larger than the distance at the front end 32, 42 of the legs 30, 40, allowing for an alignment of the drive unit coupling part 80 and the implement coupling part 110 during a coupling operation, such as for example shown in FIG. 26 to FIG. 28. During such a coupling operation, the mobile drive unit 10 is driving in a direction opposite to the direction D, or in other words backwards or in the direction of its back side 24 towards an embodiment of an implement unit 100 comprising a coupling part 110, as shown in the sequence from FIG. 26 to FIG. 27 to FIG. 28, showing different phases of an embodiment of the coupling operation. As shown, during this coupling operation the implement coupling part 110 of the implement unit 100 is suitably positioned at the lower end of the implement unit 100 such that the mobile driving unit 10 can be driven as shown towards and past a front side 122 of the implement unit 100 towards this implement coupling part 110. As shown, the implement coupling part 110 of the implement unit 100 comprises suitable guide elements 120 which cooperate with a corresponding coupling part 80 of the mobile driving unit 10 comprising guide elements 36, 46 at the inside of the legs 30, 40 of the platform 20 of the mobile drive unit 10 during coupling in order to assist alignment of the coupling part 110 of the implement unit 100 with the drive unit coupling part 80 of the mobile drive unit 10. In this way during a coupling operation, the mobile drive unit 10, by driving for example backwards, is able to proceed from an uncoupled state, such as for example shown in FIG. 26, via a guided insertion of the implement coupling part 110 in between the legs 30, 40 of the platform 20 of the mobile drive unit 10, or in other words into the recess in between the legs 30, 40 that borders the coupling part 80 of the mobile drive unit 10, the guide elements 120 of the implement coupling part 110 and the guide elements 36, 46 at the inside of the legs 46 reach alignment in which they contact each other in such a way that when the coupled state is reached, such as for example shown in FIG. 27, they form an interlocked arrangement in which the respective implement guide elements 120 contact their corresponding drive unit guide elements 36, 46. Preferably as shown, when seen from above, the shape of the implement guide elements 120 corresponds to the shape of the corresponding drive unit guide elements 36, 46. Preferably, as already mentioned above, this shape, is such that it provides for a tapered shape in which the distance between the opposing guide elements 36, 46, 120 which are in the coupled state positioned at the back end 34, 44 of the legs 30, 40 of the mobile drive unit 10 is larger than at least a part of the guide elements 36, 46, 120 positioned further towards the front end 32, 42 of the legs 30, 40 of the mobile drive unit 10. It is clear that as shown for example in FIG. 1 to FIG. 3, the platform 20 of the mobile drive unit 10 could comprise further additional guide elements 38, 48, such as for example the horizontal top guide surfaces 38, 48 of the legs 30, 40 on which corresponding horizontal coupling surfaces of the implement coupling part 110 could rest when in the coupled state, and on which these horizontal coupling surfaces of the implement coupling part 110 could slide during the coupling operation. It is further clear that an uncoupling operation generally follows the steps described above for the coupling operation but in reverse order.

As shown, for example in FIG. 26 to FIG. 28, preferably the implement unit 100, which according to such an embodiment is a towable implement unit 102 comprising a wheelset 130 at a distal end 124 of the towable implement unit 102, this means the end of the towable unit 102 facing away from the mobile drive unit 10 when coupled. It is clear that such a towable implement unit 102 is configured to be towed by a mobile drive unit 10 when coupled. As shown, preferably such a towable implement unit 102 comprises a point of gravity that is situated between the second wheelset 70 of the mobile drive unit 10, this thus means the wheelset 70 at the front side 22 of the mobile drive unit 10, and the wheelset 130 of the implement unit 100, this thus means the wheelset 130 at the back end 124 of the implement unit 110. It is clear that in the coupled state, such as for example shown in FIG. 28, in this way the point of gravity G will be positioned in such a way that the weight of the implement will rest on the horizontal coupling surfaces of the legs 30, 40 of the mobile drive unit 10, thereby enabling a stable and secure coupling and sufficient traction on the driven wheels of the mobile drive unit 10 during operation. Additionally, when coupled, preferably the point of gravity of the implement unit 100 is situated in between the legs 30, 40 of the platform 20 of the mobile drive unit 10 and/or the longitudinal axis of the legs 30, 40 when seen from above. Preferably the point of gravity of the implement unit 100 is aligned with the central longitudinal axis L of the mobile drive unit 10 as in this way the weight of the towable implement unit 100 is divided advantageously between the left and right wheels of both wheelsets 60, 70, allowing for an increased stability. Preferably, as further shown, when coupled, the point of gravity of the implement unit 100 is also situated in between the first wheelset 60 and the second wheelset 70 of the mobile drive unit 10 as this allows for an improved stability, especially during execution of the coupling operation, as it reduces the risk of the mobile drive unit from tipping over around the second wheelset 70 under influence of the weight of the implement unit 100 during the coupling operation, such as for example shown in FIG. 27. Still further, when coupled, preferably the point of gravity G of the implement unit 100 is situated above the drive unit coupling part 80 and the implement coupling part 110 as this allows a secure coupling of both coupling parts 80, 110 under the weight of the implement unit 100. It is clear that alternative embodiments are possible in which alternative arrangements of the point of gravity are possible in which one or more of the above requirements are preferably fulfilled.

As for example shown in FIG. 38 and FIG. 39, in the case of an alternative embodiment of the implement unit 100, which is a carriable implement unit 104, for example an implement unit 104 for scouting or monitoring operations, which comprises a frame 1040 on which one or more sensors 1042 are suitably mounted, such as for example suitable camera's, temperature sensors, moisture sensors, etc. for monitoring the produce, harvesting conditions, etc. It is clear that, as shown, for such a carriable implement unit 104, preferably, when coupled to a mobile drive unit 10, the point of gravity of the implement unit 100 is situated in between the legs 30, 40 of the platform 20 of the mobile drive unit 10 when seen from above and in between the first wheelset 60 and the second wheelset 70 of the mobile drive unit 10. As shown, for example in FIG. 41 to FIG. 43, preferably such an implement unit 100 also comprises a similar implement coupling part 110 with similar guide elements 120 as described above. It is thus clear that similar as described above, also for such a carriable implement unit 104, when coupled, the point of gravity G is situated above the drive unit coupling part 80 and/or the implement coupling part 110.

FIG. 4 and FIG. 5 show a similar view of the mobile drive unit 10 of FIG. 1 and FIG. 2, but with the shielding removed, thereby exposing the frame of the platform 20 and showing more clearly the internal parts and mechanisms of the mobile drive unit 10. As shown the mobile drive unit comprises one or more energy storage unit, such as for example one or more batteries. These energy storage units 140, are configured to provide energy to the mobile drive unit, for example for allowing the actuators of one or more of the wheelsets to drive the mobile drive unit along the desired path. However, preferably, the mobile drive unit 10 is also configured to provide energy to the implement unit 100 when coupled. It is clear that, preferably the mobile drive unit 10 and the implement unit 100 comprise a suitable connector which preferably automatically interlocks and enables the exchange of energy when coupled. As further shown, according to this embodiment, there are provided a plurality of sensors 12, 14, such as suitable cameras, distance sensors, optical sensors, etc. at the front and back side of the platform, for example for use during navigation and or to ensure a safe operation of the mobile drive unit 10 when in operation.

In this way, according to a particular embodiment the mobile drive units 10 of mobile drive system 1 can be seen as mobile interchangeable energy supplies for the implement units 100, thereby allowing the implement units 100 to perform prolonged operational lifetime and an increased efficiency. This can be realized by means of an embodiment of the mobile drive system 1 which is configured such that the energy level of a mobile drive unit 10 driving and powering an implement unit 100 is monitored. When the energy level of the implement and/or the mobile drive unit 10 is below a predetermined threshold, the depleted mobile drive unit 10 uncouples from the implement unit 1à0 and is automatically replaced by another mobile drive unit 10 comprising a higher energy level, for example a fully charged mobile drive unit 10 or comprising a higher charge level, which subsequently then couples to the implement unit 100 and continues to drive and/or power it. In the meantime, the depleted mobile drive unit 10 can for example be suitably recharged at a charging station 150. Such a charging station 150 is for example shown in FIG. 36 to FIG. 40.

As further shown in FIG. 5 to FIG. 10, and FIG. 12 to FIG. 13, the wheels 730, 740 of the second wheel set 70 are mounted on a pendulum plate 720 that is pivotally mounted to the frame of the platform 20 by means of a pendulum axis 710, which extends along the direction of the central longitudinal axis L. According to the embodiment shown the wheels 630, 640 of the first wheel set 60 are mounted directly on the frame of the platform 20 for rotation about an axis transverse to the longitudinal axis L. It is clear that alternative embodiments are possible in which each of the wheels is suitably mounted to the platform 20 directly, by means of a suitable pivotal system and/or by means of a suitable suspension system for providing a suitable level of dampening and/or compensation. According to a specific embodiment, instead of wheels of the first wheel set 60 that are continuously steerably mounted, it could also be advantageous to have these wheels of the first wheelset 60 mounted to their respectively so that they can be positioned in two or more fixed directional positions. According to such an embodiment the wheels 60 could be mounted, rotatable about a vertical steering axis, and suitably coupled to an actuator that is controlled to keep the wheels in one of two states, an longitudinal state, in which the wheels of the first wheelset 60 are aligned with the longitudinal axis L, such as for example shown in FIG. 12 and a transverse state, in which the wheels of the first wheelset are positioned transvers to the longitudinal axis L, such as for example shown in FIG. 14.

According to the embodiment shown the wheels each comprise a suitable wheel for driving along a suitable ground surface, however, preferably additionally, next to these ground wheels, there is provided a rail wheel that rotates around the same rotational axis, but has a reduced diameter, in this way the mobile drive unit 10 is able to be driven along a rail system, while for example using the ground wheels to drive in between two different rail systems. For example, in a typical horticultural application a rail system is arranged between each row of produce. At the end of the row, the mobile drive unit 10 can enter or leave this rail system to switch to another rail system by means of the ground wheels.

As shown in FIGS. 4 and 5, according to this embodiment, the wheels 730, 740 of the second wheel set 70, are caster wheels and comprise a drive system which is configured to actively power rotation and steering direction of the caster wheels 730, 740. The drive system, according to the embodiment shown for example comprises for example a suitable in wheel motor 732, 742, respectively actively powering the rotation of the caster wheels 730, 740. According to the embodiment shown, the drive system further comprises two steering actuators in the form of respective steering motors 734, 744, which are suitably coupled via a steering coupling 736, 746, such as for example a suitable worm drive coupling, bevel gear coupling, etc. to convert the motion of the steering motors 734, 744 to suitable rotation and angular position along a vertical steering axle of the caster wheels 730, 740, thereby defining the steering direction of the caster wheels 730, 740. According to the embodiment shown, the wheels 630, 740 are not actively driven, however, it is clear that alternative embodiments are possible in which for example also the wheels of the first wheel set 60 comprise suitable actuators for actively powering rotation and/or the steering direction of the wheels.

As shown in more detail in FIG. 6 and FIG. 7 which show a top view of the embodiment of FIGS. 4 and 5, preferably, the wheels of the wheel sets 60, 70 are mounted in a modular way, such a way that their distance with respect to the central longitudinal axis can be adjusted. As shown, each of the wheels is provided with a plurality of mounting points 638, 648, 738, 748 respectively allowing the wheels and their corresponding actuators to be mounted in a modular way at varying distances with respect to the longitudinal axis L. FIG. 8 shows a fragment of FIG. 6 in further detail, showing the plurality of mounting points 738, 748 of the second wheel set 70 in further detail. It is clear that according to the embodiment shown, the wheels 730, 740 of the second wheelset are caster wheels that are mounted via the steering coupling 734, 744 to the mounting plate 720 in which suitable openings are provided for passing the vertical steering axis of the caster wheel therethrough in the different positions with respect to the longitudinal axis L. This is further also visible in the front view of FIG. 9 and the side view of FIG. 10.

It is clear that alternative embodiments of the mobile drive unit 10 are possible, such as for example shown in FIG. 11, in which similar reference denote similar elements which function in a way similar as described above.

As shown in FIG. 12 and FIG. 13, the embodiment described above with reference to FIG. 1 to FIG. 10, is advantageous, as the steerable, driven caster wheels 730, 740 allow for a wide range of steering strategies, which for example include Ackerman steering strategies, crab like movement strategies, in place rotational steering strategies, etc. as both the wheels of the second set 70 can be suitable driven, independently, to rotate about their horizontal drive rotation axis as well as about their vertical steering rotation axis. FIG. 12 and FIG. 13 for example show two different states, in which for example in FIG. 12 the wheels of the second set 70 are aligned with those of the first set, for example allowing a suitable linear motion along a rail system, while for example in FIG. 13 the wheels of the second set 70 are both steered to a be driven in a direction transverse to the direction of the first wheel set, for example to rotate the drive unit in a minimal corridor when changing from one rail system to another. It is however clear that alternative embodiments are possible in which for example also the first wheel set 60 comprises steerable caster wheels, thereby allowing also the wheels of this first wheelset to be steered in a direction transverse to the longitudinal axis L, there by allowing a sideways movement of the mobile drive unit, thereby still reducing the required corridor for executing a transverse motion, for example for switching from one row of produce to a next parallel row.

FIGS. 15 and 16 show a bottom view, similar to that of FIG. 12 and FIG. 13, of two states of an alternative embodiment of a wheel set comprising two steerable caster wheels, which make use of linear actuators for rotating the caster wheels about a vertical steering axis as shown. As shown, the linear actuators 734, 744 at one end are mounted to the mounting plate 720 and at the other end are mounted to the caster wheels 730, 740 eccentrically with respect to their vertical steering axis, such that upon extension or retraction of the linear actuators 734, 744 the steering angle about this vertical steering axle of the caster wheels 730, 740 is controllably determined. FIG. 17 shows a top view of this embodiment, which clearly shows the preferred modular nature of the caster wheels 730, 740, which are both formed as identical modular units, comprising the linear actuator 734, 744 respectively coupled at opposing ends to a mounting plate 735, 745 which is mounted to the mounting plate 720; and a mounting plate 743 providing an eccentrical mounting point for steering the caster wheel about the vertical steering axle 737, 747, which is mounted with a suitable bearing to the mounting plate 735, 745.

It is clear that alternative embodiments of such modular wheel units are possible than those described above in which one or more of the wheelsets comprises a plurality of such identical modular wheel units, thereby increasing simplicity and robustness of the mobile drive unit, easing the control of the wheel units and reducing the number of different components of the mobile drive unit.

A further embodiment of the mobile drive unit 10 is shown in FIG. 18 to FIG. 21, in which different states of an alternative steering system is shown. As shown, according to this embodiment, the first wheel set 60 is mounted in a fixed steering position at the legs 30, 40 of the mobile drive unit 10. Different from the embodiments above, both wheels 730, 740 of the second wheelset 70 are steerably mounted to the interconnector 50 of the platform 20 at opposing ends of a pendulum shaft 750 that is pivotally mounted about a central horizontal pivot axis, which is rotationally mounted to the interconnector 50 for a steerable rotation about a vertical steering axis 770. According to a preferred embodiment the wheels of the second wheelset 70 are controlled to perform the steering actions for rotating around the steering axis 770 by means of a differential steering control of both wheels of the second wheelset 70. This is advantageous as this obviates the need for a separate steering actuator to perform this steering motion. FIG. 19 to FIG. 21 show different states in which the steering actuator positions the pendulum shaft 750 along different angular positions about the steering axis 770, thereby showing a large freedom of possible steering positions for the second wheelset 70 as the interconnector of the platform, as shown is shaped to allow the wheels and the pendulum shaft to rotate freely below the platform 20, thereby allowing for a complete rotation around the steering axis 770.

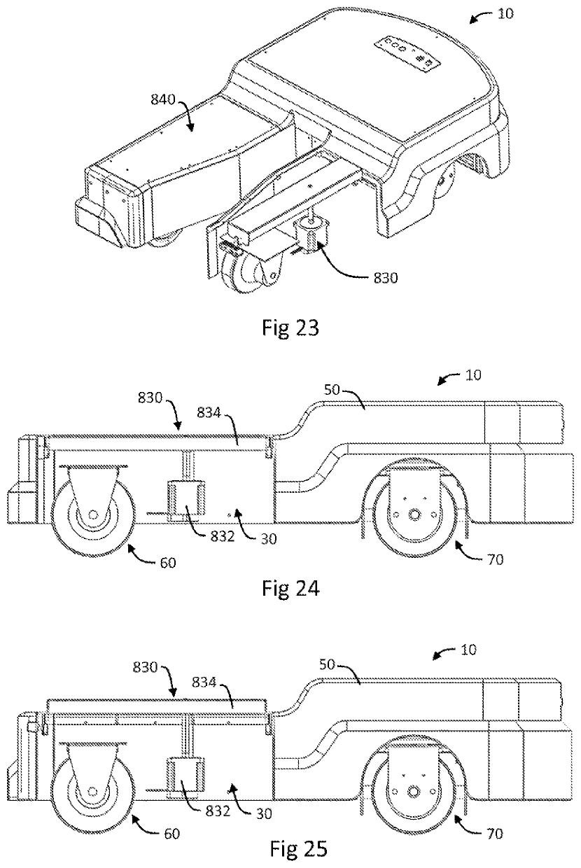

FIG. 22 to FIG. 25 show two perspective views and two side views of an embodiment of a mobile drive unit 10 comprising two lifting modules 830, 840. FIG. 22 and FIG. 24 show the lifting modules 830, 840 in the lowered position, while FIGS. 23 and 25 show these lifting modules 830, 840 in a higher raised position. It is clear that these lifting modules 830, 840 according to the embodiment shown are arranged in the legs 30, 40 of the platform 20 and allow a horizontal support surface 834, 844 of the legs 30, 40 to be suitably raised and lowered by means of a suitable actuator 832, 842. This is for example useful during coupling and/or uncoupling of an implement unit 100, in which the implement unit 100 can then be lifted from or lowered to the ground, for example at a suitable docking station. As will be explained further below it is clear that alternative embodiments of such lifting modules are possible and that these lifting modules do not necessarily need to be integrated in the mobile drive unit 10. According to alternative embodiments such implement lifting modules 830, 840 could for example also be provided as standalone units or could be integrated into the implement units 100. It is thus clear that in general according to such embodiments the mobile drive system 1 comprises at least one implement lifting module 830, 840 which is configured to lift and/or lower the implement unit 100 during coupling and/or uncoupling with the mobile drive unit 10.

According to the embodiment of the mobile drive unit shown in FIGS. 26 to 33, the mobile drive unit 10 further comprises a wheel lifting module 90 configured to lift and/or lower the wheels 630, 640 of the first wheelset 60. As shown, during the coupling or uncoupling operation, in a non-fully coupled state, such as for example shown in FIGS. 26 and 27, the wheel lifting module 90 for example keeps the first wheelset 60 in a lowered state, thereby allowing the mobile drive unit to drive around in its normal state, as shown, supported on both wheelsets 60, 70, with an orientation of its coupling part 80 in alignment with respect to the coupling part of the implement unit 100. When in the fully coupled state, such as for example shown in FIG. 28, according to such an embodiment, the coupling parts 80, 110, or other suitable parts of the implement unit 100 and the mobile drive unit 10 engage or interlock in such a way that a relative vertical movement is no longer possible, for example by means of at least one suitable interlocking pin and corresponding slot, or any other suitable interlocking mechanism. Then, as shown, when the fully coupled state is reached, and preferably before the mobile driving unit 10 starts to move the implement unit 100, the first wheelset 60 is lifted, and as the mobile drive unit 10 and the implement unit 100 are interlocked, the first wheelset 60 will thus be lifted above the ground surface. As shown, in this way, when coupled, the combination of the towable implement unit 100 and the mobile drive unit 10 comprise only two wheel sets 70, 130 at opposing sides 22, 124 of this combination, thereby allowing for a more simple, robust and reliable coupling and steering strategy as steering with only two wheelsets is more easy and robust, especially when driving in a reverse direction then with three wheelsets, and a fixed, interlocked coupling is more reliable, robust and simple, and also allows for a more simple steering strategy then a pivotable coupling. According to a further embodiment in addition to the wheel lifting unit of the drive unit, there could be provided a parking device that is integrated into the implement unit as already mentioned above. This can for example be realized by at least one parking foot, for example similar as the wheelsets one parking foot at either side of the central longitudinal axis L, such parking foots are for example suitably coupled to an actuator to be lowered to a parking state and again lifted during an operational state of the implement unit. In this way the integrated parking device is thus actuated to support such a towed implement in such a way that it prevents the towed implement to fall down in the parked state, when it is not supported by a mobile drive unit.

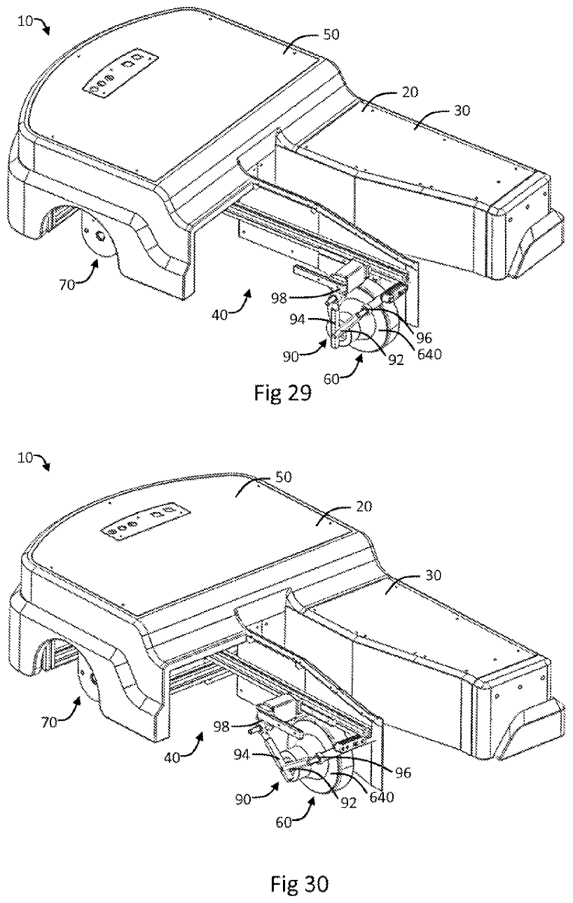

Further, as for example shown in more detail in FIGS. 29 and 30, in the uncoupled state, the wheel lifting module 90 can also function as a lifting module by lifting and lowering the distal end of the platform by means of the wheel lifting module.

According to the embodiment of the wheel lifting module 90 shown in for example FIG. 29 and FIG. 30, the wheels of the first wheelset 60 can be lifted and lowered with respect to the platform 20 of the mobile drive unit by means of a movement mechanism which comprises two links 92, 94, which are both mounted at one and to the rotational axis of the wheel, and at the other end respectively to a fixed point 96 at the frame of the platform 20; and at a sliding point, provided by a linear guide system 98 mounted to the frame of the platform 20. In this way, as shown, there is provided a triangular link system, configured to lift and lower the first wheelset 60 for example by means of a suitable actuator, not shown, defining the position of the sliding point along the linear guide.

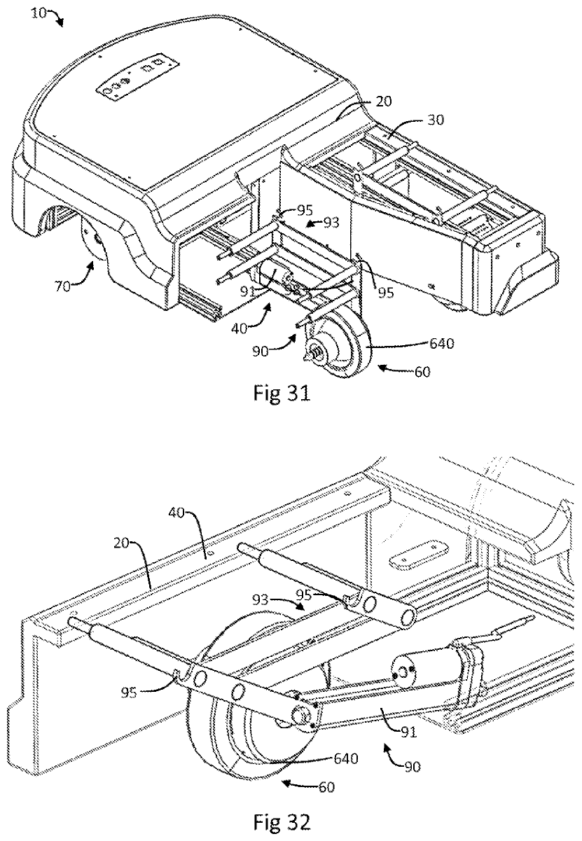

A further embodiment of the wheel lifting module 90 is for example shown in FIGS. 31 to 33, in which the lowered state is shown in FIGS. 31 and 33 and the lifted state is shown in FIG. 32. According to this embodiment, the wheel lifting module 90 comprises a parallel linkage mechanism 93 that is configured to movably mount the wheel of the first wheel set at one end of a rotatable link which is mounted at its other end to the frame of the platform 20 under the action of an actuator 91 suitably coupled to the parallel linkage mechanism 93. As shown, at the upper end of the upright links of the parallel linkage mechanism there are provided suitable hooks 95, which are put in a lowered, unlocked state when the first wheelset is in the lifted state and which are put in a lifted, locked state, when the first wheelset is in the lowered state. In this way, during a coupling operation, first the mobile drive unit 10 can approach the implement unit 100 with its first wheelset 60 in the lifted state and the hooks 95 in the unlocked state. When the coupling part of the implement unit 100 is completely inserted in between the legs of the mobile drive unit 10, then the first wheelset 60 can be moved to the lowered state, thereby lifting the legs upwards and thereby lifting the implement unit at its coupling part to complete the coupling operation. While lowering the first wheelset 60, the wheel lifting module 90 will also function to move the hooks to the raised locked state, such that at completion of the coupling operation the hooks securely lock the coupling part of the implement unit 100 onto the coupling part 80 of the drive unit 10, reducing any risk of inadvertent unlocking during operation.

FIGS. 34 and 35 show an embodiment of a mobile drive system 1 comprising a charging station 150 for the mobile drive unit 10 and/or the implement unit 100. As shown in FIG. 34 the mobile drive unit 10 approaches the charging station 150 in the same way as for coupling an implement unit 100. Subsequently the mobile drive unit 10 is removably couplable to the charging station 150 in the same way as to an implement unit 100. This thus means by means of its coupling part 80. In this way, as shown, the coupling part 80 is guided during coupling by guide elements 152 of the charging station 150 which cooperate with corresponding guide elements 36, 46 at the inside of the legs 30, 40 of the platform 20 of the drive unit coupling part 80 of the mobile drive unit 10. According to the embodiment shown, the charging station could comprise further guide elements 154 which guide the wheels of the mobile drive unit during a coupling operation. As shown, when reaching the coupled state in FIG. 35, the charging station 150 is able to exchange power with the mobile drive unit in a similar way as power is exchanged by an implement unit 100. An alternative embodiment of such a charging station 150 is for example shown schematically in FIG. 36 in which similar elements are provided with similar references and function in a similar way as described above.

According to a further embodiment, such as for example shown in FIG. 37, the mobile drive system 1 for example provides for flexibility when the drive unit approaches the charging station 150 in a coupled state with an implement unit 100. As shown, in such a state, it is preferably possible to charge both the implement unit 100 and the mobile drive unit 10 by coupling the implement unit 100 to the charging station 150. According to such an embodiment the mobile drive unit 10 could receive power directly from the charging station 150 such as described above, however, according to an alternative embodiment, it is also possible that the mobile drive unit 10 receives power from the charging station 150 via the coupled implement unit 100. As further shown according to such an embodiment there could be arranged further guide elements 82 on the top surface of the legs that cooperate and/or interlock with corresponding guide elements 182 on the implement 100.

According to still a further embodiment as shown in FIG. 38 to FIG. 40, there is shown a charging module 150, which also functions as a docking module for an implement unit 100. As shown in FIG. 38, upon approach of a drive unit 10 towards the charging station 150, the drive unit 10 is able to drive over the charging station 150 until it reaches the docked position shown in FIG. 39. In this position, upwardly extending blocking surfaces 156, 158 of the charging module 150, which functions as a docking module, and which correspond to and interlock with the coupling part 110 of the implement unit 100 to be retained on the charging module 150 upon which the drive unit 10 can continue its path to an uncoupled state as shown in FIG. 41 in which the implement unit 100 is left on the charging station 150.

FIG. 41 shows an embodiment of a monitoring or scouting implement unit 100 comprising one or more suitable sensors. FIG. 42 shows a further embodiment of a produce treatment implement unit 100 comprising a plurality of suitable light sources, such as for example UVc light sources or light sources at one or more suitable wavelengths for treatment of the produce. FIG. 43 shows an embodiment of a towable harvesting implement unit 100 comprising a robotic harvesting implement, for example a fruit picking robot arm. It is clear that above mentioned implement units 100 all comprise similar coupling parts 110, thereby allowing them all to couple with the same mobile drive unit 10.

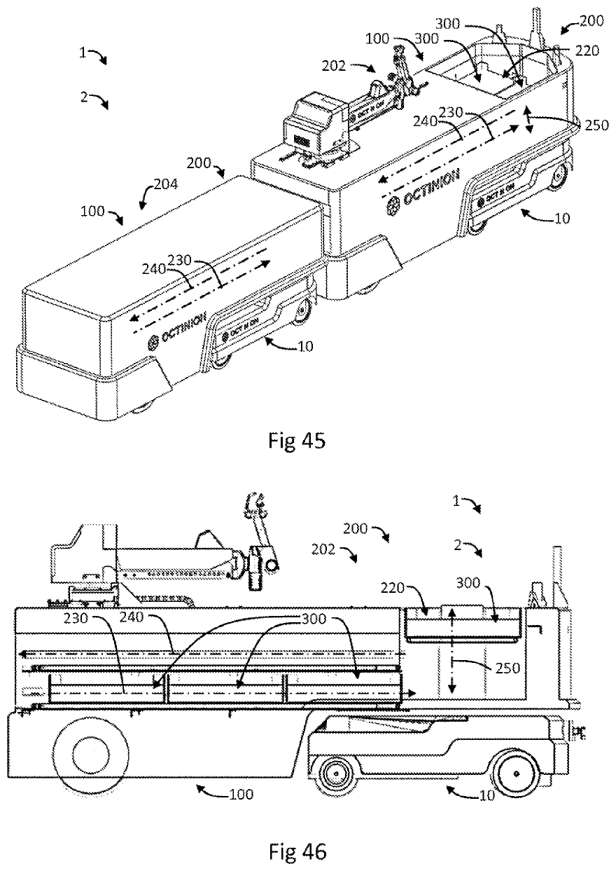

As will be described in further detail below FIG. 44 shows an embodiment of a logistics system 2 of the mobile drive system 1. Such an automated logistic system 2 comprises at least one mobile operating unit 200, in which each mobile operating unit comprises a combination of one mobile drive unit 10 coupled to at least one implement unit 100. Preferably, as for example shown in the embodiment of FIGS. 44 and 45 the automated logistic system comprises a plurality of operating units 200. According to the embodiment shown, there is provided a mobile operating unit 202 comprising a harvesting implement and a mobile supply unit 204 comprising an implement configured to provide new empty containers to the mobile operating unit 202 and to offload full containers 300 as will be described in further detail below. As shown in FIG. 44 such a mobile supply unit 204 during such an exchange of containers is positioned adjacent to the mobile operating unit 202 by its mobile drive unit 10.

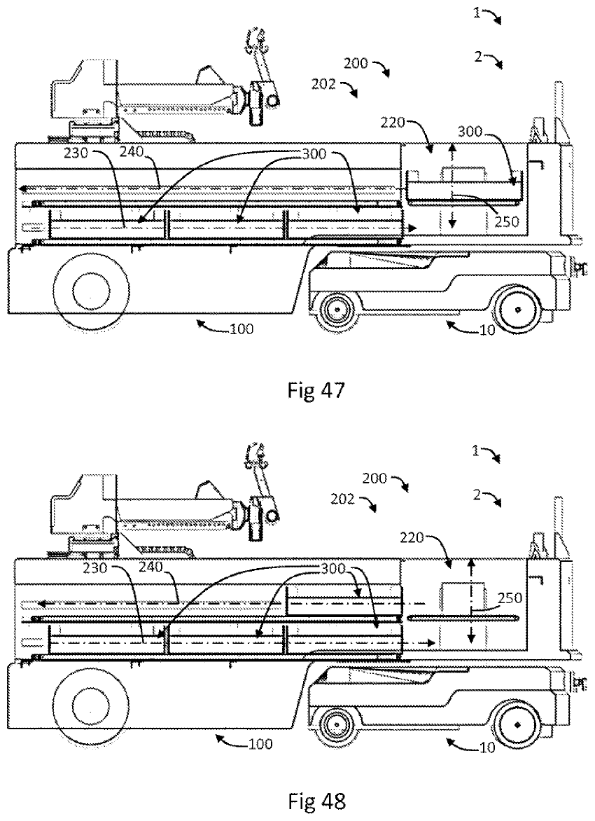

FIG. 47 to FIG. 65 show an embodiment of a mobile drive system which comprises an automated logistic system 2 comprising at least one mobile operating unit 200 in which each mobile operating unit 200 comprises a combination of one mobile drive unit 10 coupled to at least one implement unit 100. As shown, according to the embodiment of FIG. 64, in addition to two times one container 300 already being filled at an operating position 220, the mobile operating unit 200 has received a sequence of two times three empty containers 300 at an input location 210 at a predetermined input side 212 of the mobile operating unit 200. As for example show in in FIG. 45, it is clear that according to this embodiment there are arranged two containers side by side. As shown one of these containers 300 has been made available at an operating position 220, in which for example the harvesting implement can collect the harvested produce in the container. In other words, subsequently, items are placed in one or more of the containers 300, thereby changing the filling level of the one or more containers 300. As will be explained in further detail below, after the container 300 has been filled, the mobile operating unit 200 will release at least one container 300 at an output location 214 which is at the same side 212 of the mobile operating unit 200 as the input location 210. According to the embodiment shown, the output location 214 is the output end of a conveyor line located above the input end of a conveyor line for inputting the containers 300.

It is thus clear, that in such an embodiment the filling level of the containers is changed from empty to full, however it is clear that alternative embodiments are possible of mobile operating units 200 which provide for operations that empty full containers, such as for example sorting operations, etc. In general, this thus means that the filling level of the containers 300 is changed during operation of the mobile operating unit 200 from empty to full, or vice versa. The side 212 of the mobile operating unit 200 at which the input location 210 and the output location 214 is provided, is for example at the back of the mobile operating vehicle 200 when viewed along its general direction of movement D of its mobile drive unit 10.

FIG. 46 to FIG. 61 show an exemplary embodiment of the mobile operating unit 20, in which according to its method of operation, an empty container 300 is held at an operating position 220 to fill it. As shown, the inputted, empty containers 300 at the input position 210 of the mobile operating unit 200 are transported to an operating position 220 along a first transport path 230. Then at the operating position 220 the filling level of the container 300 is changed. After changing the filling level, for example when the container is sufficiently filled with harvested items, the container 300 is transported from the operating position 220 to the output position 214 along a second transport path 240 with an opposite direction to the first transport path 230. In this way the three empty containers 300 are filled and provided at a path towards the output position 214 for their subsequent removal. According to the embodiment shown, preferably the first transport path 230 and the second transport path 240 are parallel. Further, as shown the first transport path 230 and the second transport path 240 are arranged one on top of the other. It is however clear that alternative embodiments are possible in which for example they are arranged next to each other. It is clear that, according to the embodiment shown the first and/or second transport path in this way provide for a buffer for a plurality of containers. In this way they form a fifo along the transport direction. This means that the first transport path forms a fifo for empty containers and the second transport path a fifo for the filled containers. According to the sequence of the operation of the embodiment shown, at the operating position, the mobile operating unit comprises a reversing path changing module 250. As in the embodiment shown, the first and second transport path are arranged on top of each other the path changing module 250 comprises a lift. This lift receives a container at the height of the first transport path 230. After the container has been filled at the operating position 220, the lift then changes the height of the container 300 to the height of the second transport path 250 when releasing the container 300 towards the output location 214. It is however clear that alternative embodiments of such a path changing module 250 are possible in which preferably, the received container by the path changing module is reversed from direction after being filled at the operating position 220. This can for example be realised by means of a suitable conveyor that is controlled to rotate to one side when receiving an empty container, halt until the container is filled and subsequently rotate in the opposite direction to release the filled container 300. This conveyor could for example be part of the lift, as shown according to the embodiment of FIG. 46-FIG. 61. As already mentioned above, according to the embodiment shown, preferably there are arranged at least two first transport paths next to each other; and/or at least two corresponding second transport paths next to each other, each comprising an associated path changing module at an associated operating position. This allows to continue the operation changing the filling level of the container at one operating position, while another path changing module is busy with changing a container of which the filling level was changed to another transport path. In the annexes there are shown a first transport path on top of a second transport path for moving crates for an operating vehicle for harvesting. The harvested goods are deposited in the crates at an operating position where a lift system serves as a path changing module that lowers the crates once full. As shown this setup is duplicated symmetrically, one left of the vehicle and one right of the vehicle. It is clear that, while a full crate at the left side is being lowered by the lift from the operating position, to be released to the lower transport path, at the right side a crate which is not yet full can continue to receive harvested goods. When left full crate is provided to the lower transport path, the lift system raises again to the upper position of the first transport path to receive a new empty crate, upon which filling of this empty crate can be started again. It is clear that, in this way, a cyclic concept can be realized in which empty containers can be loaded and full containers can be unloaded in a double fifo queue with opposing directions at the same side of the operating vehicle. The cycle is looped at the path changing module where the direction of the fifo queue is reversed.

FIG. 62-FIG. 65 shows an embodiment of the logistics system 2 which comprises at least one mobile operating unit 200, configured as a mobile supply unit 204, which similarly comprises at least one corresponding first and second transport path 230, 240 for the containers 300. As shown, these transport paths 230, 240 are positioned such that the mobile supply unit 204 can be positioned next to the other mobile operating vehicle 202 in such a way that the first and second transport paths of that mobile operating unit 202 and the mobile supply unit 204 form a fifo along the respective transport directions 230, 240, thereby allowing an exchange of containers between the sequence of mobile operating units 200. It is clear that such a fifo, is a first in first out queue.

It is clear that still further embodiments are possible, such as for example an embodiment, wherein at least one of the transport paths, preferably the second transport path, of the operating vehicles 200 and/or the supply vehicles 204, which could also be referred to as the transport vehicle or unit 204, is provided with a cooling unit, such as for example a cooling unit for cooling harvested goods and/or supply unit 204 for determining the weight of the containers 300. According to still a further embodiment, when exchanging containers 300 between the operating vehicle 202 and the transport vehicle 204, optionally there could also be an exchange of energy between the operating vehicle 202 and the transport vehicle 204. For example, the supply vehicle 204 could in this way charge the battery of the operating vehicle 202 or there could be exchanged a depleted battery of the transport vehicle 202 with a charged battery of the supply vehicle 204.

FIG. 66 shows an embodiment of a suitable computer implemented method for operating the mobile operating system 1. As shown, according to such an embodiment there are provided a plurality of levels of Finite State Machines or FSM. According to the embodiment shown there are three levels of FSM, low, mid and high. Lower level FSM operate at a higher control loop frequency then higher level FSM. As shown, except for heartbeat error messages, which are able to determine a complete failure or shutdown of an implement unit 100 labeled as implement or a mobile drive unit 10 labeled as vehicle, when coupled, these units only exchange messages at the highest level FSM. In this way the lower level FSM are completely isolated from the lower level FSM of the other units. This increases robustness and safety of the mobile operating system 1, as all units are coordinated at the highest level FSM, without any risk of interference of the lower level FSM of other units. This is especially important when there is used a large number of implements, of for example different manufacturers. In this way, implement manufacturers only need to provide an interface at the highest level FSM for cooperation with the mobile drive unit 10. The lowest level FSM could for example handle low level control such as sensor input and suitable outputs for controllers of the actuators of the unit, the mid level FSM could for example make use of and send suitable signals to the low level FSM for executing a local mapping, local navigation, local planning routines, allowing the units to navigate and operate in a safe way along a desired path, while avoiding obstacles. The high level FSM could for example handle tasks as received from other units and/or a farm management system by means of a global task planner that schedules these tasks for implementation by the mid level FSM. It is thus clear that in this way in general, the mobile drive unit 10 and/or the implement unit 100 comprise a controller configured to operate by means of a plurality of nested control loops, each comprising one or more finite state machines, in which, when coupled to an implement unit 100, there is only exchanged operational data between the mobile drive unit 10 and the implement unit 100 at the level of the top level control loop. The sensors connected to the lower level FSM can for example have a low latency or a high latency characteristic. For the latter, preferably, a compensation for the delay can be taken into account. All sensors that provide data to perform a low-level operational instructions, for example to execute an low level operational task to follow a certain trajectory, provide their information to this lower level FSM. At the mid level FSM, which is operated at a lower control loop frequency than the low level FSM, there does not need to be made a distinction between sensors with lower and higher latency. All sensors of the drive unit or the implement unit that provide data to perform an instruction for a mid-level operational task, such as for example an operational instruction from the implement unit for the mobile drive unit to calculate a trajectory by avoiding detected obstacles, provide their this operational data to this mid level FSM.

As shown schematically, by means of the “error (heartbeat)” signal, in addition to these operational instructions, which are only exchanged at the highest level FSM, it is possible to have passive communication at lower level FSMs, for example at the mid-level FSM of different drive units and implement units. Although such a data exchange, which publish status-information which can be used by other drive units or implement units to adapt/change their behavior could be exchanged between the lower level FSMs, there is no exchange of operational instructions from one unit to another or from other sources to such units at these lower level FSMs. Such data will the ben received at for example the mid-level FSM as sensor information, which can be used by for example a local trajectory generator. Although, according to the embodiment shown, the units comprise three different levels of FSM, it is clear that alternative embodiments are possible in which in suitable plurality of levels of FSM are possible, such as for example two, three, four, etc. The number of levels of FSM could for example be related to the level of complexity of the implement unit, in which for example more complex implement units comprise a higher number of levels of FSM.

It is clear that further embodiments are possible in which in addition to communication between the drive units and/or the implement units, the mobile drive system could comprises a suitable central management system, which is involved with automatically organizing and planning the operational tasks of the different units of the mobile drive system. In the context of an agricultural or horticultural application, this could for example be referred to as a greenhouse or farm management system. In an exemplary embodiment implement units can interact in different ways with the such a management system. According to one example the implement unit could be connected with the-management system: it will exchange information on the scheduled tasks with the management system. According to such an embodiment, the implement unit can for example provide data to the management system regarding a parameter such as action radius, battery level, etc., in order to not plan tasks that are too long or with not enough charging time. When an operational instruction for starting a task sent out by the management system, the assigned mobile drive unit will for example be summoned by the management system to connect with the implement unit. Once the drive unit is connected, the implement unit will for example take over control of the mobile drive unit by means of exchange of suitable operational instructions provided to the drive unit which are exchanged at the highest level FSM. The drive unit then will only send status updates to the management system. According to a further embodiment the implement unit can interact with the mobile drive unit in order to accomplish its operational task. For example, it can command the drive unit by means of suitable operational instructions to drive to a dedicated point on the map, or drive at a suitable velocity for a treatment. As mentioned above, it is possible that the mobile drive unit can provide passive status information via a data exchange at lower level FSM, such as for example the mid-level. According to a particular embodiment of the implement unit, it can change its behavior based on this passive information exchange, or alternatively the implement unit could change its behavior, such as for example the treatment or harvesting velocity, in a suitable way in response to such data received by means of such operational data exchange. As already mentioned above at the low level FSM of the units a heartbeat signal is preferably sent between a mobile drive unit and implement unit, especially when operating in a coupled state, which allows to act immediately on a failure of one of both units.

FIG. 67 shows a suitable computer system 500 for implementing the controller or the operating system for the method and/or suitable controllers for the mobile drive system and/or the units thereof as described above. The computer system 500 may in general be formed as a suitable computer system, such as for instance an industrial computer system, a micro-controller system, a controller for a motor control, etc. and for instance comprises a bus 510, a processor 502, a local memory device 504, one or more optional input interfaces 514, one or more optional output interfaces 516, a communication interface 512, an interface for storage elements 506 and one or more storage elements 508. Bus 510 may comprise one or more guides allowing communication between the various components of the computer system. Processor 502 may comprise a generally known type of processor or microprocessor interpreting and executing programming instructions. Local memory device 504 may comprise a random access memory (RAM) or another suitable type of dynamic memory storage device storing information and instructions for execution by the processor 502 and/or a read only memory (ROM) or another suitable type of static memory storage device storing information and instructions for use by the processor 504. Input interface 514 may comprise one or more interfaces for receiving signals from an input element such as for instance a sensor, operation interfaces, etc., however it may also comprise one or more conventional mechanisms allowing the operator to enter information in the computer system 500 such as for instance a keyboard 520, a mouse 530, etc. Output interface 516 may comprise one or more output mechanisms for controlling for instance actuators, elements for displaying messages or warning signals, etc., however it may also comprise conventional mechanisms displaying output information to the operator, such as for instance a display 540, a printer 550, a speaker, etc. Communication interface 512 may comprises a suitable transceiver mechanism, such as for instance industrial or conventional network interfaces allowing the computer system 500 to communicate with other devices or systems for instance with one or more other computer systems 600 for instance of the apparatus itself, of other devices or of a management system. The communication interface 512 of computer system 500 may for instance be connected in a suitable manner with a communication network such as for instance a local area network (LAN) or a wide area network (WAN), such as for instance the internet. The interface for storage elements 506 may comprise a known storage interface such as a Serial Advanced Technology Attachment (SATA) interface or a Small Computer System Interface (SCSI) for connecting bus 510 to one or more storage elements 508, such as for instance local drives, for instance 1 TB SATA hard drives, and for controlling reading and writing of data to and/or from these storage elements 508. It is clear that alternative storage elements 508, generally any suitable computer readable medium such as for instance a removable magnetic drive, SSDs, flash-based storage devices, optical drives, ROM drives, etc. can be used. Furthermore, it is also clear that network-based storage means can be accessed via the network interface. The embodiments of the method and system as described above, can be implemented as programming instructions that are loaded into the local memory device 504 of computer system 500 for execution by its processor 502. Said programming instructions can for instance be loaded from a storage element 508 or be made accessible from another computer system 600 through the communication interface 512.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-15. (canceled)

16. A mobile drive system comprising at least one mobile drive unit capable of automated or autonomous navigation, wherein the mobile drive unit comprises:
a platform comprising U or V type shape, the platform comprising two legs and a bent or front interconnector interconnecting both legs at one end;
a first wheelset comprising two wheels, each arranged at a corresponding distal end of the legs of the platform; and
a second wheelset comprising two or only one wheel at the interconnector of the platform.

17. The mobile drive system according to claim 16, wherein the mobile drive system further comprises at least one implement unit,
wherein the implement unit is configured to be removably coupled at the legs of the platform of the mobile drive unit, such that the mobile drive unit automatically drives the implement unit when coupled.

18. The mobile drive system according to claim 16, wherein the mobile drive system is configured such that coupling of one of the mobile drive units and one of the implement units is performed by driving the mobile drive unit to the implement unit, such that an implement coupling part of the implement unit is positioned at a drive unit coupling part at the legs of the platform, and
wherein the implement coupling part of the implement unit comprises suitable guide elements which cooperate with corresponding guide elements at the inside of the legs of the platform of the drive unit coupling part of the mobile drive unit during coupling, in order to assist alignment of the implement coupling part of the implement unit with the drive unit coupling part of the mobile drive unit.

19. The mobile drive system according to claim 17, wherein the implement unit is configured such that, when coupled to a mobile drive unit, the point of gravity of the implement unit is situated:
in between the legs of the platform of the mobile drive unit and/or the longitudinal axis of the legs when seen from above;
in between the first wheelset and the second wheelset of the mobile drive unit;
above the drive unit coupling part and/or the implement coupling part; and/or
in between the second wheelset of the mobile drive unit and a wheelset of the implement unit, when the implement unit comprises a towable implement unit comprising at least one wheelset at a distal end of the towable implement unit facing away from the mobile drive unit.

20. The mobile drive system according to claim 17, wherein the mobile drive system comprises at least one implement lifting module which is configured to lift and/or lower the implement unit during coupling and/or uncoupling with the mobile drive unit, and wherein the lifting modules:
are standalone units; or
are integrated into the implement units; or
are integrated into the mobile drive units, and/or
wherein the mobile drive unit further comprises a wheel lifting module configured to lift and/or lower the wheels of the first wheelset; and/or
wherein the two wheels of the second wheelset are mounted at opposing ends of a pendulum shaft that is pivotally mounted about a central horizontal pivot axis, the central horizontal pivot axis being rotationally mounted to the interconnector of the platform for a steerable rotation about a vertical steering axis by means of a differential steering control of both wheels of the second wheelset.

21. The mobile drive system according to claim 16, wherein the mobile drive system further comprises at least one charging station for the at least one mobile drive unit and/or the at least one implement unit,
wherein the mobile drive system is configured such that the mobile drive unit:
approaches the charging station in the same way as for coupling an implement unit; and/or
is removably couplable to the charging station in the same way as to an implement unit; and/or
is guided during coupling by guide elements of the charging station which cooperate with corresponding guide elements at the inside of the legs of the platform of the drive unit coupling part of the mobile drive unit and/or with the wheels of the mobile drive unit; and/or
when approaching the charging station in a coupled state with an implement unit, thereby coupling the implement unit to the charging station, the mobile drive unit receives power from the charging station via the coupled implement unit; and/or
wherein the mobile drive unit comprises an energy storage unit and in which the mobile drive unit is configured to provide energy to the implement unit when coupled; and/or
wherein the system is configured such that the energy level of a mobile drive unit driving and powering an implement unit is monitored, and when the energy level is below a predetermined threshold, the mobile drive unit uncouples from the implement unit and is automatically replaced by another mobile drive unit which subsequently couples to the implement unit for driving and/or powering the implement unit.

22. The mobile drive system according to claim 16, which comprises an automated logistic system comprising at least one mobile operating unit, each mobile operating unit comprising a combination of one mobile drive unit coupled to at least one implement unit, whereby the mobile operating unit is configured to:
receive at least one container at an input location at a predetermined input side of the mobile operating unit;
release at least one container at an output location which is at the same side of the mobile operating unit as the input location.

23. The mobile drive system according to claim 22, wherein the mobile operating unit is further configured to manipulate items in one or more containers of the containers, thereby changing the filling level of the one or more containers; and
wherein the mobile operating unit is further configured such that:
the inputted containers at the input position of the mobile operating unit are transported to an operating position along a first transport path;
then, at the operating position, the filling level of the container is changed;
after changing the filling level, the container is transported from the operating position to the output position along a second transport path with an opposite direction to the first transport path.

24. The mobile drive system according to claim 22, wherein the first transport path and the second transport path are parallel and/or
wherein the first transport path and the second transport path are arranged one on top of the other, and/or next to each other; and
wherein the first and/or second transport path are configured to buffer a plurality of containers, preferably in a fifo along the transport direction.

25. The mobile drive system according to claim 22, wherein, at the operating position, the mobile operating unit comprises a reversing path changing module,
wherein the path changing module is configured to:
after transport of the container along the first transport direction when received from the input of the first transport path towards the exit of the first transport path;
receive a container from the exit of a first transport path;
after changing the filling level of the container at the operating position;
offer the container to the input of the second transport path;
subsequently transport the container along the opposite second transport direction when releasing the container to the input of the second transport path.

26. The mobile drive system according to claim 25, wherein at least one first and second transport path are arranged on top of each other, and
wherein the path changing module comprises a lift configured to:
receive a container at the height of the first transport path; and
change the height of the container to the height of the second transport path when releasing the container towards the output location; and/or
change the height of the container to a height different from the first and/or second transport path to an operating position in which the filling level of the container is changed, after receiving the container at the height of the first transport path and before releasing the container at the height of the second transport path.

27. The mobile drive system according to claim 25, wherein there are arranged at least two first transport paths next to each other; and/or at least two corresponding second transport paths next to each other, each comprising an associated path changing module at an associated operating position.

28. The mobile drive system according to claim 22, wherein the logistics system further comprises at least one mobile operating unit configured as a mobile supply unit, which comprises at least one corresponding first and second transport path for the containers, which, are positioned such that a sequence of at least one mobile supply unit can be positioned next to one of the at least one mobile operating units in such a way that the first and second transport paths of the mobile operating unit and the sequence of the at least one mobile supply units form a fifo along the respective transport directions, thereby allowing an exchange of containers between the sequence of at least one mobile operating units and/or at least one mobile supply units.

29. A method of operating a mobile drive system according to claim 16, wherein the mobile drive system operates at least one of said mobile drive units in shared way with a plurality of said implement units.

30. The method according to claim 29, wherein, the mobile drive unit comprises a controller configured to operate by means of a plurality of nested control loops, each comprising one or more finite state machines, in which, when coupled to an implement unit, there are only exchanged operational instructions from the mobile drive unit for the implement unit and/or vice versa at the level of the top level control loop.
